(19) United States
(12) Patent Application Publication
(10) Pub. No.: US 2026/0111819 A1
(43) Pub. Date: Apr. 23, 2026

(54) Computer-Automated Batch Optimization System and Method

(71) Applicant: Synkrato Inc., San Ramon, CA (US)

(72) Inventors: Vinnakota Charumathi, Hyderabad (IN); Sandeep Konam, Hyderabad (IN); Amin Sikander, San Ramon, CA (US)

(21) Appl. No.: 19/328,853

(22) Filed: Sep. 15, 2025

Related U.S. Application Data
(60) Provisional application No. 63/820,061, filed on Jun. 9, 2025.

(30) Foreign Application Priority Data
Oct. 23, 2024 (IN) 202421080644

(51) Int. Cl. G06Q 10/0633; G06Q 10/08

(52) U.S. Cl. CPC G06Q 10/0633; G06Q 10/08

(57) ABSTRACT

A computer-automated batch optimization system performs task scheduling and resource allocation for warehouse operations. The system comprises modules for input processing, clustering, routing/sequencing, and feedback/iteration. It processes task data and constraints, clusters tasks spatiotemporally based on available resources, and generates optimized routes for task execution. The system employs machine learning techniques and greedy algorithms to address the non-convex optimization problem, aiming to minimize tardiness and completion times while maximizing resource utilization. A feedback mechanism iteratively refines task assignments by reclustering when tardiness or earliness is detected, continuously improving operational efficiency. The system integrates with a digital twin of the warehouse and existing slotting systems, providing a comprehensive solution for optimizing warehouse management in dynamic environments.

### CROSS-REFERENCE TO RELATED APPLICATIONS

This application claims the benefit of priority of Indian Patent Application number 202421080644 filed Oct. 23, 2024, and U.S. Provisional Patent Application No. 63/820,061 filed Jun. 9, 2025, the contents of which are all incorporated herein by reference in their entirety.

### BACKGROUND

Slotting optimization refers to the strategic arrangement of items within a physical space (such as a warehouse or distribution center) to maximize efficiency and reduce the time it takes to fulfill orders. Effective slotting optimization can produce significant benefits because, in a warehouse, retrieval of goods often consumes more than 50% of the warehouse operating costs. The majority of that is “travel time”-time spent walking to locations to pick products. Manual slotting is not effective because it cannot adapt to changing supply and demand patterns. As a result, automated slotting techniques are required in order to produce significant gains in slotting efficiency.

Slotting optimization involves analyzing various factors, such as product demand, order frequency, and storage capacity to determine the most efficient placement of items. For example, a distribution center may use slotting optimization to position frequently-ordered items near the shipping area, making them easily accessible and minimizing the time it takes to pick and pack these items. In contrast, less frequently-ordered items may be stored further away to make better use of available space and prevent congestion in high-demand areas.

By utilizing slotting optimization techniques, businesses can significantly improve their order fulfillment processes. This can lead to faster processing times, reduced labor costs, and ultimately, improved customer satisfaction. For instance, an e-commerce retailer that optimizes its warehouse slots may be able to ship orders faster, resulting in shorter delivery times and happier customers. Furthermore, slotting optimization can also help minimize errors and improve inventory management. By organizing items in a logical and efficient manner, warehouse staff can easily locate products, reducing the likelihood of picking errors and ensuring accurate order fulfillment.

Implementing slotting optimization effectively, however, poses many technological and organizational challenges, such as the following:
Constantly changing inventory: Warehouse slotting optimization requires regular updates to accommodate changes in inventory. New products, seasonal items, and discontinued stock can all impact the optimal slotting configuration.
Space constraints: Limited warehouse space can pose a challenge when implementing slotting optimization. Finding the right balance between maximizing storage capacity and minimizing travel distances can be complex.
Product characteristics: Different products have varying storage requirements, such as temperature control, fragility, or hazardous materials. Incorporating these considerations into slotting optimization adds another layer of complexity.
Data Management: Slotting optimization relies heavily on data, including historical sales data, product attributes, and customer preferences. Managing and analyzing large volumes of data can be a technological challenge, requiring robust data storage and processing capabilities.
Scalability: As warehouses grow and evolve, implementing slotting optimization becomes more challenging. The technology must be scalable to handle increasing inventory levels, changing product assortments, and fluctuating order volumes while maintaining optimal slotting strategies.

More generally, slotting optimization involves the use of complex algorithms to determine the most efficient placement of items in a warehouse. These algorithms must consider factors such as item popularity, size, weight, and compatibility, making it a technologically challenging task. The direct mathematical formulation of the slotting optimization problem is NP-hard, and hence is unsolvable in polynomial time for large inputs. Even a simplified version, in which there is only one reserve and one forward area, is an NP-hard combinatorial problem. As a result, practical automated slotting optimization techniques must be able to produce gains in slotting effectiveness in the face of such computational complexity.

In addition to these challenges, warehouses face significant complexities in task scheduling and resource allocation. The dynamic nature of warehouse operations, with multiple concurrent tasks such as inbound unloading, putaway, outbound picking, packing, replenishment, and cycle counting, requires sophisticated optimization techniques. These tasks must be efficiently scheduled and allocated to available resources, considering various constraints such as worker skill sets, equipment availability, space limitations, packing station throughput, and carrier arrival times.

Furthermore, the interdependencies between different warehouse operations add another layer of complexity. For instance, the efficiency of picking tasks is directly influenced by the effectiveness of the slotting strategy. Similarly, the timing of replenishment tasks can significantly impact the performance of picking operations. Managing these interdependencies while optimizing overall warehouse performance presents a significant challenge.

Traditional approaches to warehouse task scheduling often rely on static rules or simple heuristics, which may not adequately address the complex, dynamic nature of modern warehouse environments. These methods can lead to suboptimal resource utilization, increased tardiness in order fulfillment, and overall inefficiency in warehouse operations.

What is needed, therefore, are improved techniques not only for automated slotting optimization but also for sophisticated task scheduling and resource allocation in warehouse environments. Such techniques should be capable of handling the complex, non-convex nature of the optimization problem, integrating various warehouse operations, and adapting to real-time changes in the warehouse environment.

### SUMMARY

A computer-automated system performs batch optimization for warehouse operations, addressing the complex challenges of task scheduling and resource allocation in dynamic warehouse environments. The system treats warehouse task scheduling as a non-convex optimization problem, employing greedy techniques to reach near-optimal solutions quickly.

The batch optimization system comprises four major working modules: inputs and constraints processing, clustering, routing/sequencing, and feedback/iteration. It uses both machine learning and classical routing algorithms to generate the most optimal batch of tasks that can be executed by human resources.

Key features of the batch optimization system include:
Integration of clustering algorithms with classical routing algorithms for efficient task grouping and sequencing.
Use of machine learning techniques for task optimization and resource prediction.
Comprehensive consideration of complex warehouse-specific constraints, including appointment schedules, packing station throughput, and carrier arrival times.
Handling of diverse warehouse-specific task types, such as inbound unloading, putaway, outbound picking, packing, replenishment, and cycle counting.
Calculation and minimization of both tardiness and surplus time to optimize resource utilization.
A sophisticated feedback mechanism that reassigns tasks based on performance metrics to continuously improve optimization.

The system processes input task data and constraints, groups tasks spatiotemporally, and produces clusters of similar tasks that are close together in space. It also takes into account any operational capacity constraints to further refine the clusters. This is denoted herein as multi-stage constrained clustering. It then generates an initial routing for these clusters, minimizing travel/execution time and task tardiness while considering precedence constraints. The feedback module iteratively alters the initial clustering and routing to produce an optimal solution, reassigning tasks based on tardiness and surplus time.

The batch optimization system may be used to significantly enhance warehouse operations. Additionally, when used in combination with automated slotting systems, it can further optimize overall warehouse efficiency by leveraging the synergies between optimal item placement and task scheduling. The integration of batch optimization with automated slotting can lead to improved resource utilization, reduced order fulfillment times, and increased operational agility in responding to changing warehouse conditions.

One embodiment is directed to a computer-implemented method for optimizing batch processing in a facility. The method includes receiving task data and constraints for facility operations, organizing tasks into a plurality of executable batches, generating an initial execution plan for executing tasks within each batch in the plurality of executable batches, calculating performance metrics for each batch in the plurality of executable batches, iteratively refining the initial execution plan based on the calculated performance metrics, and outputting the iteratively refined plan for assignment to facility resources.

Other features and advantages of various aspects and embodiments of the present invention will become apparent from the following description and from the claims.

### BRIEF DESCRIPTION OF THE DRAWINGS

FIG. 1 is a diagram of a computer-automated slotting system implemented according to one embodiment of the present invention.

FIG. 2 is a flowchart of a method performed by the system of FIG. 1 according to one embodiment of the present invention.

FIG. 3 is a diagram of a computer-automated batch optimization system implemented according to one embodiment of the present invention.

FIG. 4 is a flowchart of method 400 that is performed by the system of FIG. 3 according to one embodiment of the present invention.

### DETAILED DESCRIPTION

A computer-automated system performs slotting optimization based on inputs such as any one or more of the following: sales history, Advanced Shipment Notices (ASNs), picking history, current inventory, pick history, demand forecast, location placement, and multiple warehouse configuration parameters (e.g., slotting rules configurable by the user). Based on those inputs, the system detects product affinities, builds a predictive order book, and accounts for re-slotting costs and runs through multiple simulations to generate a slotting plan. The system receives feedback on its outputs and learns based on that feedback, thereby continuously improving the slotting recommendations that it generates.

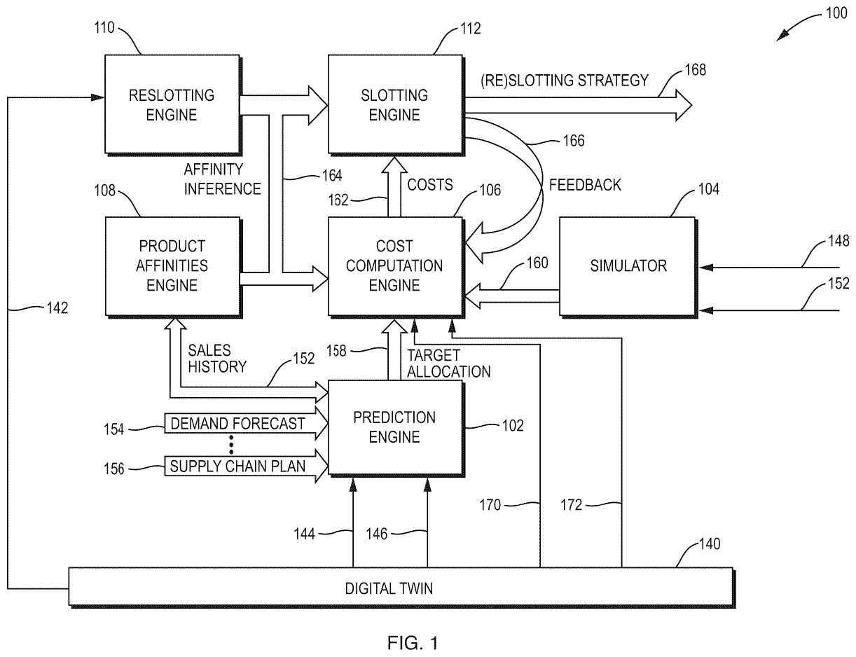

Referring to FIG. 1, a diagram is shown of a computer-automated slotting system 100 implemented according to one embodiment of the present invention. The system 100 may be used to assist with slotting in any kind of physical space, such as a warehouse or other facility. As a result, any reference herein to a particular kind of facility, such as a warehouse, should be understood to be applicable more generally to any kind of facility or other physical space.

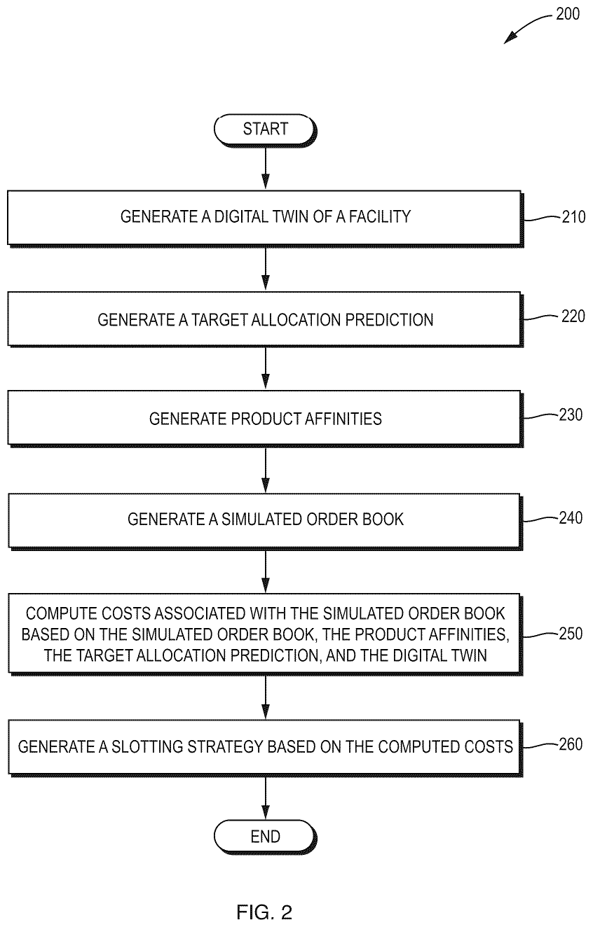

The system 100 includes a predictive engine 102, which generates a target allocation 158 (FIG. 2, operation 220). The predictive engine 102 may, for example, receive any one or more of the following as inputs, and generate the target allocation 158 based on such inputs: sales history data 152, demand forecast data 154, a supply chain plan 156, one or more Advanced Shipping Notices (ASNs) 144, and one or more inventory entries 146. The demand forecast data 154 and supply chain plan 156 may be received, for example, from an Enterprise Resource Planning (ERP) system. The demand forecast data 154 may, for example, be an output of a demand planning engine, which is used to forecast aggregate demand by time period (e.g., quarter or year) based on pastilles, promotions being run, etc. The supply chain plan 156 may, for example, represent a plan for fulfilling the demand represented by the demand forecast data 154, such as by using internal manufacturing capabilities or by buying from outside vendors. The ASNs 144 may be used to solidify supply chain plan inputs, as these are actual scheduled inbound materials. The inventory entries 146 may, for example, be used for FIFO calculations.

The target allocation 158 may include data representing a prediction of an optimal SKU_UoM allocation. (In the context of warehouse slotting, “SKU” refers to Stock Keeping Unit, and “UoM” refers to Unit of Measure. A “SKU_UoM” is a particular SKU:UoM combination. A “SKU_UoM” allocation is an allocation of SKU_UoMs.) The target allocation 158 may, for example, be a vector having the same dimensionality m as the total number of SKU_UoMs, where m is the number of SKU_UoMs that are to be allocated inside the warehouse or other facility:

$$Q = [ Q 1 , Q 2 , … , Qm ]$$

In this vector, Qi is the quantity of the ith SKU_UoM that is to be allocated inside the warehouse.

The various types of data described above, may for example, include the following:
Sales history data 152: any one or more of order ID, transaction date, item ID, SKU_UoM, and transaction quantity for each sale.
Demand forecast data 154: any one or more of item ID, SKU_UoM, period of demand, and quantity of demand predicted for each item.
Supply chain plan 156: any one or more of item ID, SKU_UoM, quantity of item, and relevant date(s) (e.g., manufacturing completion date, promised date) for each item.
Advanced shipping notices (ASNs): any one or more of order ID, item ID, SKU_UoM, SKU_UoM quantity, ASN expected date, actual shipment date, and actual receipt date for each item.
Inventory entries: any one or more of item ID, SKU_UoM, item quantity, and date of entry (e.g., receipt date, manufacturing completion date) for each receipt of inventory at the warehouse.

An ASN is a notification sent (often electronically) to a customer or consignee in advance of a shipment's arrival. It provides details about the shipment, such as the quantity, type of products, expected arrival time, carrier information, and more.

The ASN can facilitate smoother receiving processes at the warehouse or distribution center by allowing the recipient to prepare for the shipment's arrival. It helps in planning the labor and space required for unloading, inspecting, and storing the incoming goods, and it can also be used to cross-reference the delivered items with the purchase order to ensure accuracy. Overall, the ASN is an essential tool in modern supply chain management, enhancing communication and efficiency between trading partners.

The system 100 (e.g., the cost computation engine 106 described below) may use one or more order books as input. Such order books may be actual or predicted (simulated) order books. It may be useful to use simulated order books if the actual order books to be fulfilled are not known. The system 100 may include a simulator 104, which may, for example, receive sales data (such as an actual order book 148 and/or the sales history data 152) as input and generate, based on that input, a simulated order book 160 (FIG. 2, operation 240). The order book 160 may, for example, include data representing predictions of the average number and type of orders that will have to be fulfilled on a day to day basis. The simulator 104 may be executed any number of times to generate any number of simulated order books. The system 100 may minimize the average cost of fulfillment across a plurality of order books generated by the simulator 104. Note that although the following description refers to the use of the order book 160 output by the simulator 104, any function that is described herein as being performed using the order book 160 may instead be performed using an actual (non-simulated) order book.

The sales history data 152 may include, for example, for each of a plurality of sales, any one or more of the following: a transaction date of the sale, an item ID of the item sold in the sale, a SKU_UoM of the item sold in the sale, a quantity of the item sold in the sale, and an Order ID of the sale. The simulator 104 may, for example, understand the underlying pseudorandomness of sales data (e.g., the order book 148 and/or sales history data 152) within a particular period of time (e.g., one year) and generate the order book 160 based on that sales data. The order book 160 may, for example, include any one or more of the following: the number of orders, the number of distinct items in each order, the type(s) of items (e.g., item IDs) in each order, and the quantities of each distinct item in each order.

For example, the simulator 104 may use a sophisticated statistical approach to analyze the uncertainty and randomness in the sales history data 152. By understanding how that uncertainty is distributed across different aspects of the orders and applying principles from probability theory, the simulator 104 can create the order book 160 to reflect likely future orders in the warehouse. In particular, the simulator 104 may use a distributed entropy-based bootstrapping sampler which separates the potential sources of (conditional) uncertainty in a sequential manner. This sampler may work across different parts or sources of information and take into account various factors, such as product types, affinities, and seasonality. The sampler may take into account entropy in the sales history data 152, e.g., how uncertain or random different aspects of the sales history data 152 are. The bootstrapping aspect of the sampler may draw repeated samples from the sales history data 152 to make inferences from that data. The sampler may analyze the uncertainty related to different aspects of the orders in the sales history data 152 (e.g., product demand, order size) one by one, in a specific sequence. By doing so, it can consider how uncertainty in one area might affect or be affected by uncertainty in another.

The simulator 104 may extend the (conditional) chain rule of probability to distribute the entropy of randomness and use that to create the order book 160. As is well-known, the conditional chain rule allows for the calculation of joint probabilities by breaking them down into a series of conditional probabilities. The simulator 104 may apply the conditional chain rule to distribute the uncertainty across different aspects of the simulated orders in the order book 160. The simulator 104 may apply the statistical principles described above to understand the randomness inherent in the sales history data 152 and use that understanding to generate realistic data in the order book 160.

The system 100 also includes a cost computation engine 106. The cost computation engine 106 may, for example, receive any one or more of the following as inputs: the target allocation 158, an order book (e.g., an actual order book or the simulated order book 160 output by the simulator 104), an affinity inference 164, the architecture of the warehouse, the warehouse picking policy, the warehouse batching policy, and any feedback 166. The cost computation engine 106 may generate costs 162 as output, based on such inputs (FIG. 2, operation 250). The warehouse architecture that the cost computation engine 106 receives as input may, for example, be an actual architecture of the warehouse or the digital twin 140 of the warehouse described elsewhere herein. The costs 162 may, for example, include the total fulfillment cost of an order book (e.g., the order book 160 output by the simulator 104). The cost computation engine 106 may, for example, include two components: a computation component and an estimation component.

The cost computation engine 106 may, for example, receive any one or more of the following as inputs:
A digital map 172 of the warehouse, which may contain, for example, labeled XY coordinates of the entire warehouse (from the top view) and locations of slot IDs on the above coordinates, including the types of slots.
UoM conversion (i.e., the quantity of a SKU in a particular UoM).
Scales of horizontal and vertical movements, and the relative ratio between costs of horizontal movement and costs of vertical movement for a given unit distance.
Various policies and parameters 170 associated with the warehouse, such as the picking policy of the Warehouse Management System (WMS), the batching policy of the WMS, any slotting parameters, any resource allocation/limitation of the warehouse (e.g., SKU/zone restrictions), any algorithms that govern the batching of order books, and equipment information.

The cost computation engine 106 may minimize the cost to fulfill daily orders based on the current structure of the warehouse in any of a variety of ways. This cost may be computed based on the overall fulfillment and replenishment costs of the warehouse. The cost computation engine 106 may perform bilevel optimization to perform such cost minimization. Bilevel optimization in this context means that the cost computation engine 106 operates at two distinct hierarchical levels. At the upper level, strategic decisions are made concerning the overall management of warehouse resources, such as determining optimal inventory levels and setting broad slotting strategies. These decisions aim to minimize long-term operational costs and enhance the efficiency of the warehouse. At the lower level, the cost computation engine 106 focuses on operational decisions that directly impact daily activities, such as the specific allocation of tasks for order fulfillment and the scheduling of inventory replenishment. These decisions are made within the constraints and objectives set by the upper-level strategy, ensuring that daily operations align with the broader goals of the warehouse. Decisions at the lower level may provide feedback to the upper level, informing adjustments to strategies based on real-world outcomes and performance metrics. Conversely, the strategic framework established at the upper level may guide the optimization processes at the lower level, ensuring that daily operations contribute to the overarching objectives of cost minimization and operational efficiency.

By implementing bilevel optimization, the cost computation engine 106 effectively balances long-term planning with the agility needed for day-to-day operations, leading to a more cost-effective and responsive warehouse management system. This approach not only reduces the overall fulfillment and replenishment costs but also enhances the adaptability of the warehouse to changing demands and operational conditions.

Consider the following example in the context of a candy warehouse managing five specific SKUs—Skittles, Sour Patch Kids, Gummy Bears, M&Ms, and Nerds. At the upper level, the primary focus is on managing restock costs and prioritizing inventory replenishment based on demand patterns. For instance, if Skittles and Nerds experience higher demand compared to the other SKUs, the optimization model prioritizes their restocking. This strategic decision-making process involves analyzing sales data, forecasting demand, and calculating the cost implications of various restocking strategies. By prioritizing the replenishment of high-demand items, the warehouse can ensure a steady supply of these products, thereby minimizing potential sales losses due to stockouts and optimizing the use of financial resources allocated for inventory procurement.

Once the strategic decisions regarding restocking are set at the upper level, the lower level optimization takes over to handle the operational aspect of SKU distribution within the warehouse. The objective here is to arrange the units of each SKU in a manner that maximizes order fulfillment efficiency and minimizes handling costs. Given the high demand for Nerds and Skittles, the optimization model might place these items closer to the exit or in more accessible locations. This strategic placement reduces the travel time and effort required for picking these items, thereby speeding up the order fulfillment process and reducing labor costs.

The integration of upper and lower level optimizations forms a cohesive strategy that the cost computation engine 106 may use to address both the macro-level inventory management and micro-level operational efficiency. This bilevel approach allows the warehouse to dynamically adjust its strategies based on real-time data and changing market conditions. By aligning the restocking priorities with the most efficient distribution and storage strategies, the warehouse can significantly reduce the overall costs associated with inventory management and order fulfillment.

Embodiments of the present invention may use the following parameters and variables when performing bilevel optimization:
N: Total number of sections in the warehouse.
M: Total number of SKUs managed within the warehouse.
x_ij: Binary variable indicating whether SKU i can be placed in section j.
n_j: Number of slots available in section j.
sl_j: Total slots in section j.
cap_ij: Capacity of any slot in section j for SKU i.
d_i: Expected demand for SKU i over the planning horizon.
rsg_i: Restocking cost for SKU i.
eq_i: Steady-state inventory level for SKU i.
q_ij: Number of units of SKU i that fit in section j.

The upper-level optimization may focus on determining the optimal inventory levels (eq_i) for each SKU to minimize restocking costs, which are influenced by expected demand (d_i). The objective function at this level may calculate the total restocking costs by considering the proportion of products needed in the inventory and their associated restocking costs. This function is dependent on the outcomes of the lower-level optimization, forming a nested structure where the upper level sets the constraints and goals for the lower level.

Constraints that may be taken into account by the bilevel optimization process include:
The sum of products in each section equals the total number of products, ensuring that inventory levels are maintained across the warehouse.
The ratio of the number of SKUs per section to the capacity must not exceed the total number of slots available in each section.

The lower-level optimization aims to minimize the costs associated with arranging SKUs in the warehouse to efficiently fulfill orders. This involves calculating the expected cost of fulfilling an order, selected from a distribution of possible orders, given the SKU arrangement determined by the upper-level decisions. The goal is to find the most cost-effective arrangement of SKUs that facilitates quick and efficient order processing.

The combined optimization objective of the bilevel optimization process is to minimize the sum of the costs of fulfilling orders and the costs of restocking. This may be achieved by integrating the decisions from both levels, e.g.:
The lower level finds the minimum cost of fulfilling an order based on the SKU arrangement.
The upper level determines the optimal inventory levels to minimize restocking costs.

The overall system may strive to achieve the minimum combined cost, balancing order fulfillment efficiency with inventory management effectiveness. By implementing this bilevel optimization approach, embodiments of the present invention may dynamically adjust to changes in demand and operational conditions, ensuring optimal performance and cost efficiency.

The system 100 also includes a product affinities engine 108. Product affinity refers to the relationship between different products based on customer buying patterns and behavior. By analyzing historical sales data and transaction records (e.g., the sales history date 152), the product affinities engine 108 can identify patterns and correlations between products that are frequently purchased together or have a high likelihood of being purchased together, and generate an affinity inference 164 (FIG. 2, operation 230). The product affinities engine 108 may receive the sales history 152 and, based on that sales history 152, analyze and product affinities within the sales history 152, and generate the affinity inference 164 to quantify such product affinities. In particular, the affinity inference 164 may represent relationships between different items based on their co-occurrence and, in particular, frequency of co-occurrence in orders.

The product affinities engine 108 may generate the affinity inference 164 in any of a variety of ways. For example, the product affinities engine 108 may use a quasi-Bayesian approach, in which the product affinities engine 108 assumes that the entire order book consists of samples from a well-defined pseudo-random “order generator.” The product affinities engine 108 may not assume that items in a particular order are independent of each other, but may instead try to mathematically quantify how items within the order book 160 are related to each other based on the order book 160. The resulting affinity inference 164 may, for example, include data representing cause-and-effect relationship within the affinities identified by the product affinities engine 108, such as the antecedent (cause), consequent (effect), confidence (a measure of how strong or reliable the identified relationship between products is), and average ratio.

The affinity inference 164 may represent the quantities above in the form of nodal graphs, where the nodes of the graphs contain the quantities and the edges of the graphs have the confidence values associated with the nodes connected by those edges. For example, if two nodes represent two products, an edge connecting those two nodes may contain a confidence value representing a confidence that the two products co-occur within an order. The average ratio may convey that for every quantity of antecedent, the consequent quantity is X times the antecedent quantity.

Consider, for example, a graph having a Node A representing the antecedent and a Node B representing the consequent. Assume that the Node A contains an order ID of the antecedent and that Node B contains an order ID of the consequent, and that there is a directed edge from Node A to Node B, having an associated confidence value. The direction of the edge from Node A to Node B corresponds to an affinity between the antecedent and the consequent only when the antecedent is brought into the warehouse. Also associated with Node A and Node B may be average ratio values obtained by finding the average ratios of antecedent-consequent pairs in the entire order book. For example, if the average ratio value associated with Node A is X and the average ratio value associated with Node B is Y, then every time a quantity of X of the antecedent is bought, then a quantity of Y of the consequent is bought in the same order, on average. As a particular example, if X=1 and Y=1.25, then on average, whenever 1 of the antecedent is bought, then 1.25 of the consequent is bought.

The system 100 also includes a reslotting engine 110, which receives the current inventory 142 of the warehouse and the costs 162 as input, and which generates reslotting strategies (i.e., strategies for rearranging items within slots in the warehouse) in order to reduce costs related to storing and retrieving items by placing them in more optimal locations within the warehouse. The goal of the reslotting engine 110 is to generate reslotting strategies that are profitable even when taking into account the added costs that would be incurred by implementing such reslotting strategies. A reslotting strategy 168 may, for example, be generated by the reslotting engine 110 and contain data representing a list of current and suggested optimal locations in which to slot items in the warehouse.

The system 100 also includes a slotting engine 112, which receives as input the costs 162, the affinity inference 164, and the output of the reslotting engine 110 and generates, based on those inputs, the slotting strategy 168 (FIG. 2, operation 260). The slotting strategy 168 may, for example, contain data representing a slot-wise allocation of SKU_UoMs and quantities. The slotting engine 112 may also generate the feedback 166 to the cost computation engine 106.

The reslotting engine 110 and/or slotting engine 112 may, for example, receive any one or more of the following inputs
for each of a plurality of items to be slotted, the item ID, item dimensions (e.g., length, width, and/or height), and the item UoM;
labelled XY coordinates of the entire warehouse (from the top view);
aisle/slot locations based on the above coordinates;
types of slots available at the warehouse;
for each type of slot, one or more dimensions of the slot (e.g., any one or more of slot length, slot height, and slot width).
slot locations in the warehouse and their respective slot type;
one or more picking and batching policies of the WMS;
current inventory of items in the warehouse, e.g., for each item UoM, the item ID, slot ID, and quantity of the item.

The reslotting engine 110 and/or slotting engine 112 may generate the reslotting strategy and the slotting strategy 168 in any of a variety of ways. For example, for any given order book, the reslotting engine 110 and slotting engine 112 may work with a superset S of all possible configurations, with the goal of discovering the configuration having the lowest cost in the set S. (A configuration is a specific arrangement or layout of items within the warehouse that is associated with a particular set of cost.) However, the order book is not fully known. As a result, the reslotting engine 110 and/or slotting engine 112 may perform processing on expected costs of order books, rather than on deterministic (e.g., actual) costs of order books. This may be done, for example, by using the simulator 104 to generate multiple predictions/simulations of the order book for the upcoming fulfillment cycle, and attempting to find a configuration that minimizes the aggregated costs over all of these order books In this optimization process, occupancy/sparsity and the list of order books (over which we are trying to minimize costs) may together act as a fulfillment constraint.

The cardinality of the set S may be reduced by imposing an upper bound on it, thereby making it sparse. However, the reduced set would still be beyond exponential in terms of number of slots and items. As a result, even this reduction in cardinality does not reduce the computational complexity of the problem.

As described above, the predictive engine 102 may generate the target allocation 158, and the simulator 104 may perform simulations to generate the order book 160. These may be particularly useful if the order book to be fulfilled is not known (or is not fully known). However, if the order book to be fulfilled is fully known in advance, then embodiments of the present invention may generate the slotting strategy 168 without the predictive engine 102 and the simulator 104, and without generating the target allocation 158 and the order book 160.

For example, the system 100 may perform a method which analyzes the order book to be fulfilled over a specific period of time, without using the predictive engine 102 or the simulator 104. Such a method may perform item-wise summation of the order book over a windowed function of item, i.e., generate a sum, for each SKU in the order book, the quantity of that SKU that have been ordered. Such a sum may be calculated during a particular time period, such as over the past week, month, or year. This method identifies the total demand for each item (SKU) at the level of the warehouse within the particular window of time.

Embodiments of the present invention may create, store, and update a virtual representation, or “digital twin,” of an existing warehouse (FIG. 2, operation 210). This digital twin 140 is a highly sophisticated tool that provides a detailed, three-dimensional representation and view of the warehouse, aiding in the precise and automated slotting of items. Embodiments of the present invention may receive information about an existing warehouse (e.g., one or more 3D models of the warehouse) and generate the digital twin 140 based on that information. The digital twin 140 may mirror the actual warehouse's layout and features, allowing for comprehensive visualization and analysis.

More specifically, embodiments of the present invention may use 3D modeling technology to engage in a rack design phase, which may include constructing virtual racks, aisles, rows, and zones in the digital twin. Input values, such as dimensions, materials, and specific requirements may be used to ensure that the digital twin 140 accurately reflects the physical warehouse's storage components. A specialized grid drawing system may be employed to meticulously build the floor of the digital warehouse. This includes the detailed layout of different zones, rows, racks, and aisles, mirroring the exact organization of the physical space of the actual warehouse.

Embodiments of the present invention may dynamically create the walls and ceiling within the digital twin. These algorithms may consider the warehouse's actual size and shape, generating these components in a way that is true to the real-world structure. One of the innovative features of embodiments of the present invention is their ability to integrate pre-existing, or “already built,” 3D models into the digital twin's representation of the warehouse space. For example, through a simple drag-and-drop functionality, users may place these models at various locations within the digital twin, enhancing the realism and functionality of the virtual environment. As another example, embodiments of the present invention may automatically place already-built 3D models into the digital twin's representation of the warehouse. Embodiments of the present invention may provide tools that allow users to modify one or more parameters of an already-built 3D model. For example, users may use such tools to adjust the size of a storage rack or the position of partitions within a model

By creating this detailed digital twin, embodiments of the present invention facilitate automated slotting processes within the warehouse in any of the ways disclosed herein. The digital twin 140 may not be a static entity; embodiments of the present invention may continue to store and update the digital twin 140 to reflect any changes within the actual physical warehouse. Examples of changes that embodiments of the present invention may use to trigger corresponding changes in the digital twin 140 include one or more of the following:
Inventory Changes: Any changes in inventory levels, such as new stock arrivals, stock depletion, or adjustments due to audits, may trigger an update in the digital twin 140 to reflect current inventory status accurately. As another example, movements of items within the warehouse, whether temporary or permanent, may be mirrored in the digital twin 140 to maintain an accurate layout of physical stock locations.
Operational Modifications: Updates to operational processes or workflows, such as changes in picking strategies or the introduction of new packing methods, may be reflected in the digital twin 140 to simulate and analyze the impact of these changes on warehouse operations. Integration of new technologies or upgrades to existing systems, such as automated guided vehicles (AGVs) or conveyor belt systems, may be incorporated into the digital twin 140 to assess their operational efficacy and spatial requirements.
Physical Layout Adjustments: Any structural changes to the warehouse, such as the addition or removal of walls, expansion of storage areas, or reconfiguration of aisles, may be updated in the digital twin 140 to ensure it accurately represents the physical space. Modifications made to enhance safety, such as changes in emergency exit routes or updates to comply with new health and safety regulations, may be promptly reflected in the digital twin 140.
Resource Allocation: Changes in the allocation or deployment of resources, including machinery, labor, and storage equipment, may be updated in the digital twin 140 to optimize resource planning and utilization. Scheduled maintenance or unexpected downtime of equipment may be updated in the digital twin 140 to facilitate real-time planning and adjustments to warehouse operations.

In response to any of these changes, embodiments of the present invention may update the digital twin 140 automatically to enable it to remain current, thereby providing a continually accurate and valuable tool for warehouse management.

Furthermore, embodiments of the present invention enable users to quickly and easily build the digital twin 140 of the warehouse without prior knowledge of the underlying technology by enabling such digital twins to be constructed using a user-friendly drag-and-drop user interface that enables digital twins to be constructed from cuboids. Users may easily create racks of specific sizes and types, and can replicate those racks throughout an entire row.

Embodiments of the present invention may include a powerful search functionality that connects directly with the inventory backend information (i.e., information about the current inventory of the warehouse, such as the IDs and locations of items in the warehouse) in the digital twin 140. This allows users to easily locate specific items or materials within the digital twin 140 of the warehouse. By querying the detailed inventory data, users can find information about the exact location, quantity, and characteristics of items in real time, making it easier to plan and manage storage and retrieval operations.

Embodiments of the present invention offer the capability to modify the appearance of the 3D models within the digital twin 140 by altering the shader (a module that dictates how surfaces of objects within the digital twin 140 are rendered). Such modifications may include, for example, outlining versions of the materials, which may be used to highlight specific items or areas within the virtual warehouse. For example, high-priority goods or items that require special handling might be visually emphasized using this feature.

Embodiments of the present invention may maintain an open connection (socket) to listen for changes that occur on one or more associated web platforms, such as one or more Internet of Things (IoT) and/or RFID devices that can be associated with a product, equipment, or a person to track movement in real-time and reflect such movement in the digital twin 140. This may, for example, include updates from other systems, notifications from sensors, or input from users working on different devices. When any such change is detected, embodiments of the present invention may respond in real time, updating the digital twin 140 to reflect that change. This ensures that the digital twin 140 is always synchronized with the actual warehouse's current state and with other changes. For example, if an item's inventory level changes or a new shipment is recorded in a connected system, this information may be automatically reflected in the digital twin, thereby enabling accurate and up-to-the-minute slotting and other decision-making.

These additional functionalities further elevate the digital twin's value as a tool for modern warehouse management. The integration of inventory backend information provides direct insights into the status and location of goods within the digital environment. The ability to modify the appearance of 3D models enhances visual communication and understanding, and the real-time synchronization through an opened socket ensures that the digital twin 140 is constantly aligned with the actual conditions in the warehouse. Together, these features create a dynamic, interactive, and highly effective platform for managing and optimizing warehouse operations.

Embodiments of the present invention may use a 3D development platform, such as the Unity engine from Unity Technologies. Such a 3D development platform may be leveraged to enable developers to create complex and interactive 3D models of a warehouse for the digital twin. For example, Unity offers various functionalities, including physics engines, rendering capabilities, and a wide range of built-in components that can be used to model real-world behavior within the virtual environment. Embodiments of the present invention may use Object Oriented Programming (OOP) methodology to obtain the fullest potential of the 3D development platform's component workflow.

To ensure seamless communication with the backend services, embodiments of the present invention may implement an Application Program Interface (API), such as a REST (Representational State Transfer) API. This API acts as a bridge, enabling the exchange of information between the digital twin 140 and other backend systems, such as the inventory management system. The use of a REST API ensures standardized communication and allows for the real-time updating of information, such as inventory levels, product details, and warehouse configurations.

Embodiments of the present invention may include a user interface element, also referred to herein as an “information panel,” which displays pertinent data about the warehouse's status, inventory, and operations. The backend services feed this information to the information panel, thereby keeping users informed about and engaged with the digital twin.

Embodiments of the present invention may use a pathfinding algorithm, such as the A* (A star) pathfinding algorithm, which is a popular and widely-used algorithm in computer science for finding the shortest path between nodes in a graph. It has applications in various domains, including video games, robotics, and network routing. Examples of other pathfinding algorithms including Dijkstra's Algorithm, the Bellman-Ford Algorithm, Greedy Best-First Search, and Jump Point Search. Embodiments of the present invention may use any pathfinding algorithm to calculate the most efficient paths for moving items within the warehouse, considering various factors like distances, coordinates, and time consumed. In the context of slotting plan functionality, a pathfinding algorithm (such as the A* algorithm) may be used to aid in determining optimal storage locations for items, taking into account the warehouse layout, item characteristics, and other constraints. This ensures that the slotting plan is both efficient and effective. By optimizing the distances and routes, embodiments of the present invention may help to minimize the time and effort required for various warehousing activities, such as picking, placing, and replenishing items.

In summary, embodiments of the present invention may integrate cutting-edge programming methodologies, interactive design features, and intelligent algorithms to create a sophisticated and dynamic digital twin 140 of the warehouse. By harnessing the power of Object-Oriented Programming, Unity's capabilities, REST API communication, and A* pathfinding, embodiments of the present invention may offer a comprehensive and versatile tool for modern warehouse management, enhancing visualization, decision-making, and overall efficiency.

The reslotting engine 110 and slotting engine 112 may generate the slotting strategy 168 in any of a variety of ways. For ease of explanation, the following description will refer to the slotting engine 112 as generating the slotting strategy 168, although in practice the slotting strategy 168 may be generated by the reslotting engine 110 and/or the slotting engine 112.

The slotting engine 112 may model the warehouse (using the digital twin) as a union of cuboids, and may treat each floor in the warehouse as a 2D array containing a plurality of shelves. A “section” of the digital twin 140 is a collection of slots. The digital twin 140 may include a plurality of sections. Within each section, all of the slots are standardized (e.g., all of the slots have the same dimensions, such as length, width, and/or height). Slots in different sections, however, may have different dimensions. The plurality of sections do not intersect, and the union of the plurality of sections equals the entire warehouse, as modeled by the digital twin.

Embodiments of the present invention may allow the digital twin 140 of the warehouse to include one or more “bulk locations,” where a bulk location is defined as an area in the warehouse that is assumed to be able to accommodate all types of slots.

Embodiments of the present invention may measure the cost of traveling (“travel cost”) from one slot to another based on the distance between those slots, measured in the manner just described. More generally, embodiments of the present invention may use costs as a proxy for distance. As a result, cost minimization may imply minimization of a summation of the relevant distances. Examples of types of costs that the cost computation engine 106 may calculate and use as proxies for distance include:
Picking Costs: The costs associated with the process of retrieving (“picking”) items from their storage locations in the warehouse to fulfill orders. This is a critical aspect of warehouse operations, especially in facilities that handle a high volume of orders. Picking costs may include for example, labor costs, equipment costs, error costs, energy costs, and/or impact of picking on other operations. Embodiments of the present invention can work with varying picking costs across slots. This would also make the algorithm applicable to “Golden Areas” which may have lesser picking costs in the warehouse compared to other slots.
Travel Costs: The costs associated with traveling from one location to another within the warehouse.
Dropping Costs: Time necessary to drop off items at a destination locator—e.g., offloading items from fork lift/pallet jack and physically placing them in the rack.
Replenishment Costs: The costs associated with replenishing a particular SKU_UoM into a slot in the warehouse. Each SKU_UoM may have an associated replenishment cost. Different SKU_UoMs may have different associated replenishment costs.

The cost computation engine 106 may calculate any of the costs described above and include the resulting calculated costs in the costs 162. Any of a variety of changes associated with the warehouse may cause the costs 162 calculated by the cost computation engine 106 to change. For example, if the technology of the warehouse changes or expands (e.g., a new escalator or new intra-floor conveyor is installed in the warehouse), then the cost computation engine 106 may update its calculations of the costs 162 to reflect such changes to the warehouse. As another example, if a new wall is constructed or removed in the warehouse, this may alter travel costs and/or dropping costs in the warehouse, and the cost computation engine 106 may update its calculations of the costs 162 to reflect such changes to the warehouse.

In the context of warehouse operations, an “order book” refers to a comprehensive record or ledger containing all the orders that a warehouse has received. These orders typically come from customers or other parts of the business and represent requests for specific goods to be shipped or delivered. Examples of the contents of an order book include the following:
Order Details: This includes information about each order, such as the products requested, quantities, order date, requested delivery date, customer details, shipping address, and any special instructions.
Status Tracking: The order book may also track the status of each order as it moves through various stages of processing, picking, packing, shipping, and delivery. This helps in coordinating different parts of the warehouse operation and provides visibility into the status of outstanding orders.
Priority Handling: Orders might be prioritized in the order book based on factors like delivery deadlines, customer importance, or the nature of the goods. This can guide the order in which items are picked and shipped.
Integration with Other Systems: The order book may be part of a larger Warehouse Management System (WMS) or Enterprise Resource Planning (ERP) system, allowing it to integrate with other aspects of the business, such as inventory management, shipping, and billing.

An order book may be divided into batches. Such grouping into batches may be based, for example, on factors such as order priority, delivery location, and product type. Each batch represents a collection of orders that will be handled together. Such batches may, for example, be of equal size. The batches may, for example, be fulfilled sequentially across batches.

A warehouse “batching policy” is the method or strategy used to group orders into batches for more efficient processing within the warehouse. This is a part of the warehouse's overall order fulfillment strategy, which aims to optimize the picking, packing, and shipping processes. Batching policies can vary based on the specific needs and priorities of the warehouse, but they generally focus on grouping orders in a way that maximizes efficiency and minimizes costs, such based on order similarity, order priority, order size, equipment and labor utilization, shipping considerations, and a desire to align with the warehouse picking strategy. By implementing an effective batching policy, a warehouse can significantly improve the efficiency and accuracy of its operations, reducing costs and enhancing customer satisfaction.

“Processing” a batch involves dividing the fulfilled batch across different shelves, sections, or aisles and allocating specific tasks to the picking staff. This is a more detailed step that organizes how the fulfilled orders will be handled within the warehouse. It may involve things like sorting the items for final packaging, labeling, or assigning specific orders to specific workers or teams.

After a batch is processed, it is “fulfilled,” which means that the items for all the orders within that batch have been collected, packed, and are ready for shipment. Fulfillment is the overall process of getting the ordered items from their storage locations and preparing them for delivery to the customers. It includes everything from picking the items off the shelves to packing them in shipping boxes.

A warehouse may have a picking policy. A picking policy is a set of rules or strategies that govern how items are selected and retrieved from their storage locations in the warehouse. Different policies may prioritize efficiency, accuracy, speed, or other factors. Common picking policies might include wave picking, zone picking, or batch picking. A picking policy may, for example, follow a First In First Out (FIFO) strategy, with the assumption that the SKU_UoMs that are slotted first are fulfilled first if they are available at more than one location in the warehouse.

Each batch may be further divided based on the aisles where the items are located into “aisle orders.” Such division may be performed in accordance with the warehouse's picking policy (such as the FIFO strategy). The information about which items to pick from each aisle is made available to the relevant personnel or systems for every batch. This helps to coordinate the picking process across different parts of the warehouse.

A “stage” is a designated area where picked items are gathered, organized, and prepared for the next step in the fulfillment process, such as packing or shipping. Bringing items to the stage is part of the process of getting them ready to leave the warehouse. The picking policy deployed by the warehouse determines the way in which specific products (SKU_UoMs) in the required quantities are collected and prepared (brought to the stage) to fulfill the orders in each batch. Hence, the total cost of fulfillment operations is a function of the order book, the warehouse picking policy, the warehouse batching policy, and the warehouse structure.

Each warehouse typically has a “main stage,” which is a central area or hub within the warehouse where items are collected, processed, or staged after being picked from the aisles. The main stage is a designated space that acts as a connecting point or common area where items from different aisles are brought together for further processing, such as packing, sorting, or shipping.

As one example of an embodiment of the present invention, consider the following test case, in which every aisle in the warehouse has a designated area at the bottom, called the “aisle stage” for that aisle, which serves as a temporary holding or staging area for items that have been picked from that aisle. To get items from the slots (shelves) in the aisle to the aisle stage, vertical movement is used, meaning items are moved straight down to the aisle stage area. The aisle stage in each aisle can be accessed from the main stage (central area) of the warehouse using only horizontal movements. This separation of vertical and horizontal movements aids in efficient navigation and handling within the warehouse.

In this particular example, after receiving communication about what to pick from each aisle, the staff pick the required items and move them vertically downward to the aisle stage of that aisle, in readiness for further movement. Once all such vertical picking has been completed in the aisles, the warehouse staff transitions to the horizontal picking stage, in which all items held in the respective aisle stages of the aisles are moved solely horizontally to the main stage. This final step consolidates all picked items in the main stage (central area), where they can be further processed (e.g., packed and shipped). However, embodiments of the present invention are able to scale beyond the above-mentioned warehouse staging policy and picking policy.

The example process above represents a methodical and structured approach to picking that leverages the physical layout of the warehouse to maximize efficiency. By separating the picking process into vertical and horizontal stages and utilizing dedicated staging areas at the end of each aisle, the warehouse can streamline the movement and handling of items, potentially reducing the time and effort required to fulfill each order.

To accommodate the above-described warehouse geometric model, different types of costs, and various aspects of warehouse operations, embodiments of the present invention may use a modular slotting system of the kind shown in FIG. 1.

One of the advantageous features of embodiments of the present invention is their ability to continuously learn and improve based on user feedback. By receiving feedback on its outputs, the system is able to identify areas of improvement and refine its slotting recommendations. This adaptive learning process ensures that the system constantly enhances its performance, resulting in increasingly accurate and effective slotting plans.

In order to generate the most optimal slotting plan, embodiments of the present invention may run through multiple configurations and use such simulations to take into consideration various factors, such as re-slotting costs, warehouse parameters, and user-defined slotting rules when generating slotting recommendations. By evaluating different scenarios, the system is able to compare the efficiency of each plan, ultimately providing the most cost-effective and streamlined solution.

Embodiments of the present invention may be used to produce significant improvements in efficiency and cost reduction for warehouse operations. By maximizing product accessibility, minimizing travel distances, and optimizing storage capacity, the system may be used to ensure that inventory management becomes more streamlined and cost-effective.

Instead of relying on manual labor to determine the most efficient placement of inventory items within the warehouse, embodiments of the present invention may be used to automate the slotting process. By analyzing historical sales data, order patterns, and other relevant factors, embodiments of the present invention intelligently identify the optimal locations for each item in the warehouse.

For example, consider a retail company that offers a wide range of products, from small accessories to large appliances. Traditionally, warehouse employees would spend a significant amount of time manually organizing and reorganizing the inventory to ensure efficient storage and retrieval. This process not only required a substantial labor force but also led to errors and inefficiencies due to human limitations.

By using embodiments of the present invention, such a retail company may eliminate the need for manual slotting entirely by automatically calculating the optimal placement for each item based on sales data, product characteristics, and other relevant factors. This not only reduces labor costs associated with slotting but also minimizes the risk of errors and improves overall operational efficiency.

Furthermore, embodiments of the present invention provide flexibility and adaptability. As a business grows or changes its product mix, embodiments of the present invention may easily adjust the slotting strategy to accommodate new items or changes in demand patterns. This eliminates the need for costly and time-consuming physical reconfigurations of the warehouse layout.

A company that uses an embodiment of the present invention to perform slotting may significantly reduce upfront capital investments. A software-based solution that implements an embodiment of the present invention may leverage existing infrastructure and only require a computer system with sufficient processing power. This makes it accessible and affordable for businesses of all sizes, from small startups to large enterprises.

Embodiments of the present invention may generate a predictive order book: a forecast of the orders that will typically be fulfilled in a particular period of time. This ability provide a variety of benefits, such as:
Improved Inventory Management: By forecasting the orders that will typically be fulfilled, the warehouse can manage inventory levels more efficiently. This ensures that there is enough stock to meet anticipated demand without overstocking, which would tie up capital and potentially lead to obsolescence.
Enhanced Supply Chain Coordination: With a predictive view of future orders, coordination with suppliers can be optimized. This means timely reordering, negotiating better terms with suppliers, and aligning production schedules if manufacturing is involved.
Better Resource Allocation: Knowing in advance what orders are likely to come in helps in planning the labor and equipment needed to process those orders. This can lead to more efficient scheduling and utilization of resources, reducing operational costs.
Reduction in Stockouts and Overstocks: Accurate predictions help in maintaining the right balance of inventory, reducing the chances of stockouts (where an item is unavailable) or overstocks (where too much of an item is kept). This helps in maintaining customer satisfaction and reduces holding costs.
Strategic Planning Support: Forecasting the order book can be a vital tool for long-term strategic planning. It can guide decisions on warehouse expansion, technology investments, partnerships with suppliers, and other strategic initiatives.
Risk Mitigation: Predictive analytics can also identify potential risks in the supply chain, such as dependence on a single supplier for a critical item. By foreseeing potential challenges, steps can be taken to mitigate these risks before they become issues.
Agility in Responding to Market Changes: With a clear understanding of future demand, a warehouse can be more agile in responding to market trends and changes. If a sudden surge or drop in demand is predicted, the warehouse can respond quickly to capitalize on opportunities or minimize losses.

Embodiments of the present invention may generate slotting recommendations which take reslotting costs into account, and which attempt to minimize such reslotting costs. This ability provides a variety of benefits, such as:
Cost Efficiency: Reslotting can be an expensive and labor-intensive process. Minimizing these costs can lead to significant savings, allowing resources to be allocated elsewhere in the warehouse.
Optimized Space Utilization: Proper slotting ensures that products are placed in the most efficient locations within the warehouse. This optimal use of space can increase the capacity of the warehouse and make material handling more efficient.
Reduced Labor Costs: By minimizing the need for reslotting, the warehouse can reduce the labor costs associated with moving products from one location to another. This can also reduce the risk of worker fatigue and related injuries.
Improved Picking Efficiency: Slotting that takes into account the frequency and co-occurrence of picks can reduce travel time for pickers. This leads to faster order fulfillment and can have a positive impact on customer satisfaction.
Increased Agility and Responsiveness: By continually analyzing and adjusting slotting to minimize reslotting costs, the warehouse becomes more agile and can respond more quickly to changes in order patterns or inventory levels.

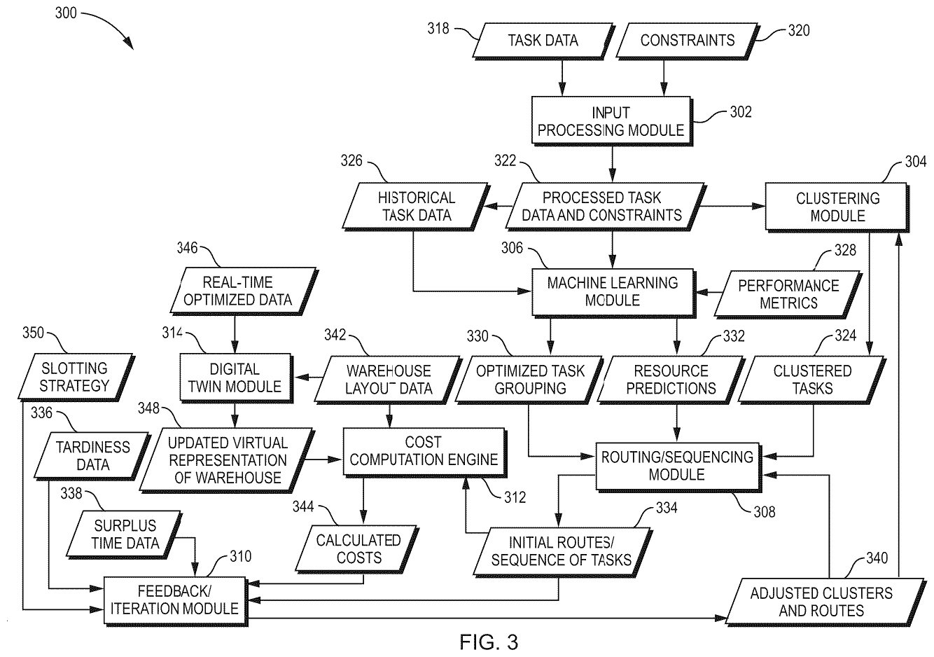

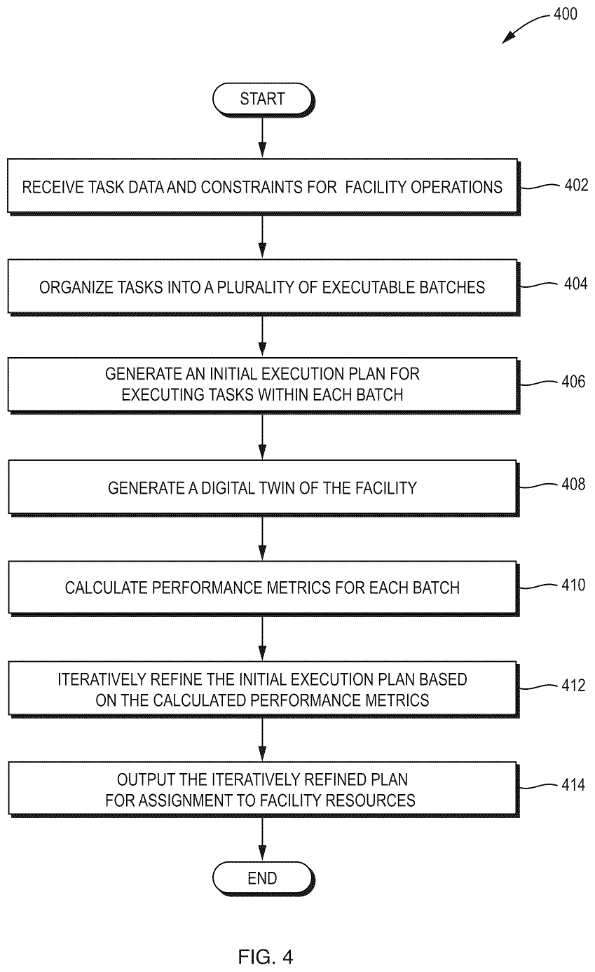

Referring to FIG. 3, a diagram is shown of a computer-automated batch optimization system 300 implemented according to one embodiment of the present invention. The system 300 may be used to optimize task scheduling and resource allocation in any kind of facility, such as a warehouse or distribution center. Although a warehouse is one example of a “facility,” as that term is used herein, embodiments of the present invention may be used in connection with any kind of facility, including but not limited to manufacturing plants, hospitals, retail stores, airports, schools, and/or office buildings. Referring to FIG. 4, a flowchart is shown of a method 400 that is performed by the system 300 of FIG. 3 according to one embodiment of the present invention.

The batch optimization problem addressed by the system 300 is a non-convex optimization problem, where the cost function may be a function of various parameters such as tardiness, earliness, completion times, resource utilization, travel distance, energy consumption, equipment wear, labor costs, and/or throughput rates. An ideal or optimal solution would optimize any combination of two or more of these parameters. For example, embodiments of the present invention may minimize tardiness and completion times while maximizing resource utilization, or may minimize travel distance while optimizing labor costs and throughput rates. However, given the complex nature of the problem and the need for a near-optimal solution in a short amount of time, the system 300 may employ greedy techniques to efficiently reach a viable near-optimal solution based on the specific parameters selected for optimization in a particular implementation.

Before describing the components and operation of the system 300 of FIG. 3 in detail, a high-level overview of the purpose, operation, and benefits of the system 300 will be described. The batch optimization system 300 is designed to efficiently manage and optimize task scheduling and resource allocation in warehouse and distribution facilities. Its primary purpose is to organize and execute multiple warehouse tasks, such as inbound unloading, putaway, outbound picking, packing, replenishment, and cycle counting, while considering various constraints and resource limitations.

The system 300 operates by processing input task data and constraints, clustering similar tasks considering capacity constraints, generating optimized routes and sequences, and continuously refining these plans through a feedback mechanism.

The system 300 operates by processing input task data and constraints, clustering similar tasks considering capacity constraints, generating optimized routes and sequences, and continuously refining these plans through a feedback mechanism. In some embodiments of the present invention, the system 300 may utilize machine learning and/or non-machine learning techniques to analyze historical data and improve future predictions. In some embodiments, the system 300 may maintain a digital twin of the warehouse to enhance accuracy in decision-making.

Benefits of embodiments of the system 300 may include any one or more of the following:
Increased efficiency: By optimizing task grouping and sequencing, the system minimizes travel time and reduces overall task completion times.
Improved resource utilization: The system allocates resources based on their skill sets and availability, maximizing productivity.
Reduced tardiness: Through intelligent task scheduling and continuous optimization, the system minimizes delays in order fulfillment.
Adaptability: The system can quickly adjust to changes in warehouse conditions, inventory levels, and order patterns.
Integration with existing systems: The batch optimization system can work in conjunction with automated slotting systems, providing a comprehensive warehouse optimization solution.

By addressing the complex, non-convex optimization problem of task scheduling in warehouses, the system 300 provides a near-optimal solution in a time-efficient manner, leading to significant improvements in overall warehouse operations and productivity.

Returning now to FIG. 3, the system 300 includes an input processing module 302, which receives task data 318 and constraints 320 for facility operations as inputs. The task data 318 may, for example, include information about various warehouse operations, such as inbound unloading, putaway, outbound picking, packing, replenishment, and cycle counting. The constraints 320 may, for example, include factors such as appointment schedules, packing station throughput, carrier arrival times, and resource availability.

The system 300 also includes a clustering module 304, which receives the processed task data and constraints 322 from the input processing module 302. The clustering module 304 organizes tasks into a plurality of executable batches by grouping tasks based on spatiotemporal similarity, creating clustered tasks 324 that are similar in nature and close together in space.

A machine learning module 306 is also part of the system 300. This module 306 analyzes historical task data 326, performance metrics 328, and the processed task data and constraints 322 to generate optimized task groupings 330 and resource predictions 332.

The system 300 also includes a routing/sequencing module 308. The outputs of the clustering module 304 and the machine learning module 306 feed into the routing/sequencing module 308. The routing/sequencing module 308 generates an initial execution plan 334 for executing tasks within each batch in the plurality of executable batches, aiming to minimize travel/execution time and task tardiness while considering precedence constraints.

A feedback/iteration module 310 in the system 300 receives the initial execution plan 334 along with tardiness data 336 and surplus time data 338. This module 310 calculates performance metrics for each batch in the plurality of executable batches and iteratively refines the initial execution plan based on the calculated performance metrics, reassigning tasks to continuously improve optimization.

A digital twin module 314 in the system 300 receives warehouse layout data 342 and real-time operational data 346 to generate and maintain an updated virtual representation of the warehouse 348.

The system 300 also includes a cost computation engine 312, which calculates costs 344 such as travel time and tardiness based on the initial execution plan 334 and warehouse layout data or an updated representation of the warehouse 348.

Finally, an integration module 316 in the system 300 outputs the iteratively refined plan for assignment to facility resources, connecting the batch optimization system 300 with an automated slotting system (not shown), allowing for the generation of an integrated warehouse optimization plan 354 that leverages the synergies between optimal item placement and task scheduling based on a slotting strategy 350, batch optimization results, and the output of the digital twin module 314.

Having described the system 300 at a high level of generality, specific embodiments of the system 300 will now be described in more detail.

The input processing module 302 serves as the initial data processing component of the batch optimization system 300, receiving task data 318 and constraints 320 for facility operations (FIG. 4, operation 402). The input processing module 302 may receive task data 318 that includes detailed information about various warehouse operations such as inbound unloading, putaway, outbound picking, packing, replenishment, and cycle counting. The constraints 320 may include operational parameters and limitations that define the boundaries within which the system 300 operates, such as appointment schedules, packing station throughput, carrier arrival times, and resource availability. The input processing module 302 processes these inputs to generate processed task data and constraints 322, which represents a refined, structured, and validated version of the input data optimized for use by subsequent modules in the system 300.

The input processing module 302 may receive two inputs:
Task data 318: This includes detailed information about various warehouse operations such as inbound unloading, putaway, outbound picking, packing, replenishment, and cycle counting.
Constraints 320: These are operational parameters and limitations that define the boundaries within which the system 300 must operate. Examples include appointment schedules, packing station throughput, carrier arrival times, and resource availability.

The input processing module 302 processes these inputs to generate a single output: the processed task data and constraints 322. This is a refined, structured, and validated version of the input data, optimized for use by subsequent modules in the system 300.

To produce this output, the input processing module 302 may perform data validation to check incoming data for completeness and accuracy, data normalization to standardize formats and units across different sources, and data structuring to organize information for efficient processing by the clustering module 304 and machine learning module 306. The input processing module 302 may perform initial data analysis to identify basic patterns or trends and constraint integration to incorporate operational limitations into the processed data structure.

In some embodiments, the input processing module 302 may handle configurable operational parameters that allow the batch optimization system 300 to be tailored to specific warehouse environments. These facility configuration parameters may include inbound stage details that specify locations, capacities, and operational characteristics of receiving areas, and outbound stage details that define shipping area configurations, dock assignments, carrier scheduling requirements, and staging area capacities. The input processing module 302 may process scheduling parameters such as work shift start and end times to align batch optimization with facility operating schedules, ensuring that task assignments respect labor availability and shift transitions.

Deadline management parameters for pending tasks may allow the system 300 to prioritize time-sensitive operations and adjust batch compositions based on urgency levels. Task management parameters may include cluster criteria options that specify whether tasks should be grouped by equipment capacity limitations, spatial proximity, task type similarity, or other operational factors. Task priority toggles may be enabled or disabled to determine whether the batch optimization system 300 should incorporate priority-based scheduling into the clustering and routing processes, allowing high-priority tasks to be expedited when necessary. By performing these functions, the input processing module 302 ensures that data entering the batch optimization system 300 is clean, consistent, and properly structured for effective operation of subsequent modules.

The task data 318 may include information about warehouse operations including at least one of inbound unloading, putaway, outbound picking, packing, replenishment, or cycle counting. The task data 318 may include task location information that specifies where within the facility each task is to be performed, such as specific aisle locations, rack positions, or work stations. The task data 318 may contain task type information that categorizes tasks based on their operational characteristics, such as whether a task involves material handling, inventory management, or quality control activities. The task data 318 may contain quantity information, specifying how many items need to be processed, moved, and/or handled for each task.

The task data 318 may include required skill sets for task execution, which specify the qualifications, certifications, or experience levels needed for personnel to perform particular tasks. For example, some tasks may require forklift operation certification, while others may need specialized knowledge of hazardous material handling procedures. Equipment requirements may be part of the task data 318, indicating what machinery, tools, or devices are needed to complete specific tasks, such as conveyor systems, scanning equipment, or lifting apparatus. Resource allocation preferences may be part of the task data 318, indicating which personnel or equipment are preferred for specific tasks based on efficiency considerations or operational constraints.

Task deadline information may be included in the task data 318 to specify when tasks must be completed. This temporal data may include hard deadlines for time-sensitive operations, preferred completion windows for routine tasks, and/or priority levels that indicate the relative urgency of different tasks. The task data 318 may specify estimated duration for each task, providing time estimates based on historical performance data or standard operating procedures. In some cases, the task data 318 may include dependency information that identifies relationships between tasks, such as which tasks must be completed before others can begin.

The constraints 320 may encompass a wide range of operational parameters and limitations that define the boundaries within which the system 300 operates. Precedence constraints may define dependencies between tasks, wherein certain tasks may be completed before other tasks can be initiated. For example, putaway tasks may need to be completed before inventory becomes available for picking operations, or quality control inspections may need to occur before items can be moved to shipping areas.

Capacity constraints may limit the number of tasks that can be assigned to each resource or executed within a specific time period. These constraints may reflect physical limitations such as the maximum number of pallets a forklift operator can handle per hour, the throughput capacity of packing stations, or the storage capacity of staging areas. Temporal capacity limitations may restrict how many concurrent operations can occur in specific zones or time windows.

Equipment-specific constraints may define volume and weight limitations for particular equipment types used in warehouse operations. Volume constraints may specify the maximum cubic capacity that equipment such as forklifts, pallet jacks, or automated guided vehicles can handle in a single batch or trip, while weight constraints may define the maximum load capacity that equipment can safely transport. The batch optimization system 300 may use these equipment-specific constraints during the clustering and routing processes to ensure that task groupings remain within the physical capabilities of available equipment, potentially dividing large batches into smaller sub-batches or adjusting task assignments when necessary.

Spatial constraints may define physical limitations within the facility, including aisle accessibility, equipment positioning, and storage area restrictions. For example, certain aisles may be too narrow for specific equipment types, or particular storage areas may have height restrictions that limit the types of items that can be stored there. These constraints may specify zones where only certain types of operations can occur, such as temperature-controlled areas for perishable goods or secure areas for high-value items.

Resource availability constraints may reflect the actual availability of personnel and equipment, including shift schedules, equipment maintenance windows, and skill-based limitations where only certain workers are qualified to perform specific tasks. These constraints may account for equipment sharing scenarios where multiple tasks compete for the same resources, such as shared forklifts or scanning devices.

Temporal operational constraints may include appointment schedules that specify when inbound shipments are expected to arrive or when outbound carriers are scheduled for pickup, influencing task prioritization and sequencing to ensure that receiving and shipping operations align with external schedules. Packing station throughput constraints may define the maximum processing capacity of packing operations, influencing how picking tasks are scheduled to avoid bottlenecks. Carrier arrival times may be incorporated to ensure that outbound tasks are completed in time for scheduled pickups.

Regulatory and operational constraints may include safety requirements that mandate specific procedures, rest periods for workers, or restrictions on handling certain types of materials. Quality control requirements may specify inspection procedures or testing protocols that may be completed before tasks can be considered finished.

The clustering module 304 is responsible for grouping similar tasks based on their spatiotemporal characteristics, considering both spatial proximity within the warehouse and temporal relationships between tasks. Within the method 400, the clustering module 304 clusters tasks based on similarity and spatial proximity as part of organizing tasks into a plurality of executable batches (FIG. 4, operation 404). The clustering module 304 may receive as input the processed task data and constraints 322 from the input processing module 302, and the primary output is clustered tasks 324, which represents groups of tasks that are similar in nature and close together in space.

The clustering module 304 may consider task interdependencies when forming clusters, wherein dependent tasks are grouped to minimize waiting times between related operations. For example, the clustering module 304 may group putaway tasks with subsequent picking tasks that depend on the putaway completion, or may cluster quality control inspections with the packing tasks that require those inspections to be completed first. By grouping interdependent tasks together, the clustering module 304 may reduce idle time and improve overall operational efficiency.

To produce the clustered tasks 324, the clustering module 304 may perform spatiotemporal analysis of task locations and deadlines, compute distances as traversable paths through the warehouse layout, assess task similarity based on type and resource requirements, employ unsupervised machine learning techniques to identify natural groupings, and incorporate operational constraints to ensure feasible cluster formation.

In some embodiments, the clustering module 304 may implement Delivery ID clustering as a constraint criterion, where tasks are grouped based on their associated Delivery ID to ensure that tasks belonging to the same delivery are clustered together. The Delivery ID clustering may override spatial proximity considerations when necessary to maintain delivery integrity, ensuring that all tasks related to a specific delivery are processed as a cohesive unit. The clustering module 304 may apply Delivery ID clustering in combination with other constraint criteria, such as equipment capacity limitations or task type similarity, to create clusters that satisfy multiple operational requirements simultaneously. This approach may prevent the fragmentation of delivery-related tasks across different clusters, which could otherwise lead to inefficient processing or coordination difficulties during task execution.

The clustered tasks 324 serve as intermediate organizational units that are transformed into executable batches through additional considerations such as resource availability, capacity constraints, and operational scheduling requirements. While clusters represent spatiotemporally similar tasks, batches represent the final executable collections assigned to facility resources. A single cluster may be divided into multiple batches based on resource limitations, or multiple clusters may be combined when operational constraints permit consolidation. The routing/sequencing module 308 may receive the clustered tasks 324 to generate an initial execution plan 334, while the feedback/iteration module 310 may reassign tasks between batches based on performance metrics such as tardiness data 336 and surplus time data 338.

The machine learning module 306 may enhance the batch optimization process through predictive analytics and continuous learning. Within the method 400, the machine learning module 306 analyzes historical data and generates optimized task groupings and resource predictions. This module 306 may support various operations in method 400, particularly during the organization of tasks into executable batches (FIG. 4, operation 404) and the generation of the initial execution plan (FIG. 4, operation 406). The machine learning module 306 receives three primary inputs: the historical task data 326, the processed task data and constraints 322, and the performance metrics 328. The machine learning module 306 produces two main outputs:
Optimized task grouping 330: This represents an improved organization of tasks based on historical patterns and current operational data.
Resource predictions 332: These are forecasts of resource utilization and availability to support efficient task execution.

To produce these outputs, the machine learning module 306 may perform data analysis to identify patterns and correlations in historical and current operational information, predictive modeling using machine learning algorithms to forecast task completion times and resource utilization, task grouping optimization by leveraging historical performance data, and continuous learning to update models based on new data.

Resource prediction capabilities may forecast resource requirements and availability based on historical utilization patterns and current operational demands. In some embodiments, the machine learning module 306 may perform packing throughput optimization by analyzing the relationship between picking activities and packing station capacity to prevent bottlenecks in downstream operations. This optimization may calculate optimal pick personnel allocation by determining the number of pick personnel required for each task type to ensure that pick throughput does not exceed packing station processing capacity. For example, analysis of historical data may determine that a particular packing station can process a maximum of 100 items per hour, leading to recommendations that limit pick personnel assignments to ensure picking activities for items destined for that packing station do not exceed this throughput limit. The packing throughput optimization may consider factors such as item complexity, packing requirements, and station-specific processing capabilities when generating personnel allocation recommendations.

For generating optimized task groupings 330, various machine learning techniques may be employed. Supervised learning algorithms such as random forests or gradient boosting may classify tasks based on their characteristics and historical performance patterns, analyzing features such as task type, location, duration, priority level, and resource requirements to identify optimal grouping patterns. Unsupervised learning techniques such as k-means clustering or hierarchical clustering may discover natural groupings within the task data that may not be immediately apparent through manual analysis. In some embodiments, reinforcement learning approaches may be employed where the module learns optimal task grouping strategies by receiving feedback on the performance of previous groupings, with successful groupings being reinforced in future iterations.

For generating resource predictions 332, time series forecasting models such asARIMA (Autoregressive Integrated Moving Average) or LSTM (Long Short-Term Memory) neural networks may predict future resource availability and requirements based on historical patterns. These predictions may account for cyclical patterns in warehouse operations, such as daily, weekly, or seasonal variations in activity levels. Regression models may predict task completion times based on various factors including task complexity, resource skill levels, and historical performance data. In some cases, ensemble methods that combine multiple prediction algorithms may improve accuracy and robustness. Bayesian optimization models may be used to predict near-optimal resource requirements for the processed task data and operational constraints. The resource predictions 332 may include not only the quantity of resources needed but also the specific skill sets required for optimal task execution, enabling more precise resource allocation within the system 300. The outputs of the machine learning module 306—the optimized task grouping 330 and resource predictions 332—serve as valuable inputs for the routing/sequencing module 308, as will be described next.

The routing/sequencing module 308 is responsible for determining the optimal order of task execution within each batch. Within the method 400, the routing/sequencing module 308 generates an initial execution plan for executing tasks within each batch in the plurality of executable batches (FIG. 4, operation 406). The routing algorithms employed by the routing/sequencing module 308 may be super linear in runtime complexity, meaning that the computational time required increases more than proportionally with the size of the input problem. This characteristic makes the reduction in problem size achieved through clustering particularly advantageous for overall system performance. The routing/sequencing module 308 may receive the optimized task grouping 330, the resource predictions 332, the clustered tasks 324, and adjusted clusters and routes 340 (described in more detail below).

The main output of the routing/sequencing module 308 is an initial execution plan 334. This represents the optimal order for executing tasks within each batch, taking into account various constraints and optimization goals. To produce this output, the routing/sequencing module 308 may integrate various operational constraints into the routing process, calculate and optimize travel time between tasks within each batch, prioritize tasks to minimize delays, assign tasks to available resources using the resource predictions 332, and determine the most efficient order of task execution within each batch.

In some embodiments, the routing/sequencing module 308 may implement deadlock prevention mechanisms to detect and resolve potential deadlocking dependencies between tasks. Deadlocking dependencies may occur when two or more tasks create circular dependencies, such as task A requiring completion of task B while task B simultaneously requires completion of task A. The routing/sequencing module 308 may employ deadlock detection algorithms that analyze task dependency graphs to identify potential circular dependencies before they can cause system deadlock. When potential deadlocks are detected, the routing/sequencing module 308 may apply deadlock resolution strategies such as task reordering, dependency breaking, or resource reallocation to eliminate the circular dependencies. The deadlock prevention mechanisms may continuously monitor task relationships during the routing process, ensuring that the generated execution sequences remain free of deadlocking conditions that could halt warehouse operations.

By considering multiple factors simultaneously, the routing/sequencing module 308 may generate an initial execution plan 334 that aims to minimize overall completion time, reduce tardiness, and maximize resource utilization. This initial execution plan 334 serves as a valuable input for the iteration module 310, as described in more detail below.

The initial execution plan 334 may contain several detailed components that together form a comprehensive task execution strategy. These components may include a task sequence matrix that specifies the precise order in which tasks within each batch should be executed, resource assignment mappings that pair specific resources with particular tasks based on skill requirements and availability, detailed travel path specifications that outline optimal routes for resources moving between task locations, and time windows for each task specifying earliest start times and latest completion deadlines. The initial execution plan 334 may contain contingency instructions that provide alternative execution paths if certain conditions arise during implementation, performance metrics projections that estimate expected completion times and resource utilization rates, priority override parameters that allow high-priority tasks to be expedited when necessary, and synchronization points that identify when multiple resources need coordination.

Referring to FIG. 3, the initial execution plan 334 may contain equipment allocation schedules that specify when and where specialized warehouse equipment should be deployed to support task execution. These schedules may be designed to maximize equipment utilization while ensuring availability for critical tasks. The routing/sequencing module 308 may generate these detailed components using various algorithms, including greedy heuristics, dynamic programming approaches, and constraint satisfaction techniques that balance multiple optimization objectives simultaneously.

As an example of complex routing scenarios, warehouse operations may employ two-step picking processes that utilize intermediate drop-off locations (IDOLs) to optimize material flow and resource utilization. Two-step picking operations may involve a first movement phase where items are retrieved from storage locations within aisles and transported to designated intermediate drop-off locations, followed by a second movement phase where items are consolidated from the intermediate drop-off locations to final staging areas. The intermediate drop-off locations may serve as temporary consolidation points that enable more efficient coordination between picking activities and downstream operations such as packing and shipping. Each aisle or warehouse zone may have one or more designated intermediate drop-off locations strategically positioned to minimize travel distance while providing convenient access for subsequent consolidation activities. Following the initial picking phase, consolidation activities may involve different personnel or equipment, enabling task specialization and more efficient resource allocation. The batch optimization system 300 may incorporate two-step picking operations into the task scheduling and routing processes by considering both the initial picking movements and subsequent consolidation movements when generating execution plans, ensuring that intermediate drop-off locations do not become bottlenecks in the overall workflow.

The digital twin module 314 is responsible for creating and maintaining a virtual representation of the warehouse environment. Within the method 400, this module generates and updates a digital twin 140 (FIG. 1) of the warehouse (FIG. 4, operation 408).

The digital twin module 314 receives two primary inputs:
Real-time operational data 346: This includes current information about warehouse operations, such as inventory levels, equipment status, and resource availability.
Warehouse layout data 342: This provides detailed information about the physical structure and organization of the warehouse.

The main output is the digital twin 140, which may have any of the properties described above in connection with FIG. 1. The digital twin module 314 may implement bidirectional path assumptions when calculating routes and distances within the warehouse layout, where paths between any two locations are treated as bidirectional, meaning that travel cost or distance remains the same regardless of direction of travel. This bidirectional path assumption may simplify route calculations and ensure consistent distance measurements throughout the warehouse optimization process. Additionally, single-level warehouse assumptions may be implemented where all walkable paths are assumed to be on the same floor and elevation. In such implementations, the warehouse may be modeled as a single horizontal plane, eliminating the need to account for vertical movement between different floors or elevation changes within the facility. This single-level assumption may simplify pathfinding calculations by reducing the complexity of three-dimensional navigation to two-dimensional route planning, allowing the routing/sequencing module 308 to focus on horizontal movement optimization without considering vertical transportation requirements such as elevators, ramps, or multi-level storage systems.

In some embodiments, the digital twin module 314 may integrate with facility sensors to receive real-time operational data, and the method 400 may further comprise automatically updating task assignments based on real-time facility condition changes reflected in the digital twin 140. Sensor data may be received from various facility monitoring systems, including inventory level sensors, equipment status monitors, environmental condition sensors, and personnel tracking systems. When changes in facility conditions are detected through sensor integration, the system 300 may automatically trigger reassignment of tasks to optimize performance based on the updated facility state reflected in the digital twin 140.

The digital twin module 314 may create walkable path maps that define the navigable routes within the warehouse environment using specific node and intersection definitions. A network of nodes may be generated that represent key intersection points where multiple walkable paths converge or diverge, such as aisle intersections, corridor junctions, or transition points between different warehouse zones. Each node may be assigned unique coordinates within the warehouse coordinate system and may contain metadata describing the types of paths that connect at that location. Walkable paths may be defined as linear segments that connect pairs of nodes, representing the actual routes that warehouse personnel and equipment may traverse during task execution. These walkable paths may be characterized by attributes such as path length, maximum width for equipment passage, and accessibility restrictions for specific types of resources. The walkable path network may be constructed by analyzing the physical warehouse layout and identifying all feasible routes between storage locations, work stations, and staging areas, providing a comprehensive representation of warehouse navigation options that enables the routing/sequencing module 308 to calculate optimal travel sequences and distance measurements for task execution planning.

The feedback/iteration module 310 is responsible for calculating performance metrics for each batch in the plurality of executable batches and for iteratively refining the initial execution plan 334 based on these calculated performance metrics. Within the method 400, the feedback/iteration module 310 calculates performance metrics for each batch (FIG. 4, operation 410) and uses these metrics to iteratively refine the initial execution plan 334 generated by the routing/sequencing module 308 (FIG. 4, operation 412).

The feedback/iteration module 310 may calculate various types of performance metrics to evaluate batch efficiency and operational effectiveness. Tardiness metrics may measure the amount of time by which individual tasks or entire batches exceed their designated deadlines or scheduled completion times. Surplus time metrics may indicate excess time remaining after task completion, representing the difference between minimum task deadlines and actual batch completion times. For example, surplus time for a cluster j may be calculated as: surplus time (cluster j)=max (0, min (deadlines (task i))-completion time (cluster j)), where N is the number of tasks in cluster j. Resource utilization efficiency metrics may measure the ratio of productive task execution time to total allocated resource time for each batch, providing insight into how effectively warehouse personnel and equipment are being used.

To generate these performance metrics, the feedback/iteration module 310 receives and processes several inputs: tardiness data 336 that provides information about delays in task completion, surplus time data 338 that indicates excess time remaining after task completion, calculated costs 344 from the cost computation engine 312 representing total fulfillment costs, and slotting strategy 350 that provides information about optimal item placement within the warehouse. The slotting strategy 350 allows the iterative refinement process to leverage optimal item placement information to make batch optimization more effective by ensuring that task sequences align with efficient item retrieval patterns.

The cost computation engine 312 plays a supporting role in the performance metrics calculation process by providing detailed cost analysis that enables comprehensive batch evaluation. The cost computation engine 312 may receive the initial execution plan 334 from the routing/sequencing module 308 and the updated virtual representation of the warehouse 348 from the digital twin module 314. The cost computation engine 312 may calculate travel costs associated with movement between task locations, labor costs based on resource allocation and task duration, equipment utilization costs, energy consumption costs, opportunity costs related to resource idle time, and/or penalty costs associated with missed deadlines or service level agreements.

These calculated costs 344, combined with the slotting strategy 350, enable the feedback/iteration module 310 to generate performance metrics that combine tardiness, surplus time, resource utilization, spatial efficiency, and financial efficiency data to evaluate the overall effectiveness of each batch. Performance metrics may include composite efficiency scores that combine multiple metrics into single performance indicators, completion time variance metrics, throughput rates, and cost-per-task ratios that provide detailed insight into batch performance and guide optimization decisions.

In some embodiments, the feedback/iteration module 310 may implement specific methods for comparing optimized paths against historical pick operations to validate the effectiveness of the batch optimization system 300. Historical operational data that includes actual pick sequences, completion times, and travel distances from previous warehouse operations may be received and analyzed. Distance metrics may be calculated by reconstructing historical pick paths using timestamp data from dispatch and completion records, enabling determination of actual travel distances and sequences followed during historical operations. Comparative performance metrics may be generated by calculating the total distance traveled in historical operations versus the optimized paths generated by the batch optimization system 300, providing quantitative measures of improvement potential. Consistent distance calculation methodologies may use the same walkable path networks and distance measurements for both historical reconstruction and optimized path generation, ensuring accurate comparisons between actual and optimized performance. Validation reports may demonstrate the effectiveness of the batch optimization approach by showing measurable improvements over historical performance, providing evidence-based support for the optimization strategies implemented by the system 300. For a more detailed description of the cost computation engine 312 (also referred to as element 106 in FIG. 1) and its functionalities, please refer to the description of FIG. 1 above.

To iteratively refine the initial execution plan 334 and produce the adjusted clusters and routes 340, the feedback/iteration module 310 may perform performance analysis to evaluate tardiness and surplus time data, cost assessment to determine configuration efficiency and identify cost-saving opportunities, task reassignment based on performance analysis and slotting strategy information, cluster optimization to minimize surplus time when no tardiness exists, route refinement to adjust task sequences within clusters, and feedback mechanism application that reclusters tasks when tardiness exceeds predetermined thresholds.
Performance analysis: The feedback/iteration module 310 may evaluate the raw tardiness and surplus time data to identify areas for improvement in the current task sequences and cluster assignments.
Cost assessment: Using the calculated costs, the feedback/iteration module 310 may determine the efficiency of the current configuration and identifies potential cost-saving opportunities.
Task reassignment: Based on the performance analysis and slotting strategy information, the feedback/iteration module 310 may reassign tasks with high tardiness to clusters with surplus time, aiming to balance the workload and reduce overall tardiness while considering optimal item placement patterns. Additionally, the module may combine multiple batches into fewer batches when capacity constraints and other operational constraints permit such consolidation.
Cluster optimization: If there is no tardiness in any task, the feedback/iteration module 310 may focuses on minimizing surplus time by reassigning tasks between clusters, taking into account the slotting strategy to ensure that task groupings align with efficient warehouse layout and item accessibility.
Route refinement: The feedback/iteration module 310 may adjust the sequence of tasks within clusters to further optimize performance and reduce costs, leveraging slotting information to ensure that task sequences follow optimal paths through the warehouse based on item locations.
Feedback mechanism application: The feedback/iteration module 310 may apply a feedback mechanism that reclusters tasks when tardiness exceeds a predetermined threshold in any batch, enabling dynamic reorganization of task assignments to address performance bottlenecks and maintain operational efficiency.

Based on the comprehensive analysis of performance metrics, costs, and slotting strategy information, the feedback/iteration module 310 iteratively refines the initial execution plan 334 by repeating the process of analysis and adjustment until certain convergence criteria are met, such as achieving zero tardiness, minimizing surplus time, or reaching a set number of iterations (FIG. 4, operation 412). This iterative refinement process continuously modifies the initial execution plan 334 through successive adjustments to task assignments and sequences, aiming to continuously improve the overall efficiency of warehouse operations through each iteration while leveraging optimal item placement information from the slotting strategy.

The feedback/iteration module 310 may employ specific convergence criteria to determine when the optimization process should terminate. These criteria may include, for example, any one or more of the following:
Achieving zero tardiness/earliness (or a minimum threshold) and minimized surplus time across all clusters.
Detecting no significant change in tardiness or surplus time for a set number of consecutive iterations (e.g., 5 iterations).
Reaching a predetermined time limit for the feedback process (e.g., 5 minutes).

When any of these convergence criteria are met, the iteration module 310 may consider the iteratively refined execution plan to be sufficiently optimized for practical warehouse operations. This approach ensures that the system 300 can provide a near-optimal solution within a reasonable timeframe, balancing the need for iterative refinement of the initial execution plan 334 with the real-time demands of warehouse management.

As mentioned above, the system 300 may use greedy techniques to efficiently reach a viable near-optimal solution. These greedy techniques may involve making locally optimal choices at each step of the optimization process, with the aim of finding a global optimum. For example, the feedback/iteration module 310 of the system 300 may use a greedy approach when reassigning tasks with high tardiness to clusters with surplus time, aiming to balance the workload and reduce overall tardiness. Similarly, the routing/sequencing module 308 may use greedy algorithms to determine the most efficient order of task execution within each cluster, considering factors such as task dependencies, resource constraints, and operational goals. While these greedy techniques may not always guarantee the absolute optimal solution, they provide a practical and efficient method for addressing the complex non-convex optimization problem in a timely manner, which is crucial for real-time warehouse operations.

Following the completion of the iterative refinement process and satisfaction of convergence criteria, the feedback/iteration module 310 outputs the iteratively refined plan for assignment to facility resources (FIG. 4, operation 414). The adjusted clusters and routes 340, which represent the final iteratively refined execution plan, may be formatted and transmitted to various facility management systems and resource allocation platforms. The output process may involve multiple distribution channels to ensure that the iteratively refined execution plan reaches the appropriate facility resources, including transmission to warehouse management systems, mobile devices or handheld terminals used by warehouse personnel, and machine-readable instructions that coordinate with automated equipment. The iteratively refined execution plan may be output in various formats depending on facility requirements, including visual displays for supervisors, detailed work orders for workers, contingency plans for alternative task assignments, and integration with existing facility management systems to automatically update inventory tracking, equipment scheduling, and workforce management databases.

Embodiments of the present invention may provide several advantages over conventional warehouse management approaches. Traditional warehouse task scheduling often relies on static rules or simple heuristics that may not adequately address the complex, dynamic nature of modern warehouse environments. In contrast, embodiments of the batch optimization system 300 may employ sophisticated spatiotemporal clustering techniques that group tasks based on both spatial proximity and temporal relationships, potentially leading to more efficient resource utilization and reduced travel times compared to conventional approaches.

The technical approach employed by embodiments of the present invention addresses fundamental computational challenges inherent in warehouse optimization problems. For example, exhaustive search methods in non-convex optimization problems may require exponential time for convergence, making such approaches impractical for real-time warehouse operations. Embodiments of the present invention may address this computational complexity by coupling clustering and routing algorithms, which may reduce the problem size that the routing module 308 processes. This reduction in problem size may be particularly advantageous because routing algorithms are typically super linear in runtime complexity, meaning that even modest reductions in problem size may yield significant improvements in computational efficiency. The feedback/iteration module 310 may employ greedy search techniques to reach near-optimal solutions quickly, providing a practical balance between solution quality and computational speed that may be suitable for dynamic warehouse environments.

Referring to FIG. 3, embodiments of the system 300 may integrate multiple optimization modules, including the clustering module 304, machine learning module 306, and routing/sequencing module 308, to address the non-convex optimization problem of warehouse task scheduling. This integrated approach may provide advantages over traditional systems that typically handle different aspects of warehouse operations in isolation. For example, conventional systems may optimize slotting separately from task scheduling, potentially missing opportunities to leverage synergies between optimal item placement and task execution sequences. Embodiments of the present invention may address this limitation through the integration module 316, which may combine slotting strategy 350 information with batch optimization results to generate an integrated warehouse optimization plan 354.

The machine learning module 306 may provide advantages over static optimization approaches by analyzing historical task data 326 and performance metrics 328 to generate optimized task groupings 330 and resource predictions 332. Traditional warehouse management systems may rely on predetermined rules that do not adapt to changing operational patterns or seasonal variations in demand. In contrast, embodiments of the machine learning module 306 may continuously learn from historical performance data and adjust optimization strategies accordingly, potentially leading to improved accuracy in resource allocation and task scheduling over time.

Embodiments of the feedback/iteration module 310 may offer advantages over conventional batch processing systems through the implementation of dynamic task reassignment based on real-time performance metrics. As shown in FIG. 4, the iterative refinement process (operation 412) may continuously adjust task assignments based on tardiness data 336 and surplus time data 338, potentially reducing delays and improving overall operational efficiency. Traditional systems may execute predetermined task sequences without the ability to adapt to real-time conditions, potentially leading to suboptimal resource utilization when unexpected delays or equipment failures occur.

The digital twin module 314 may provide advantages over conventional warehouse layout representations by maintaining an updated virtual representation of the warehouse 348 that incorporates real-time operational data 346. Traditional warehouse management systems may rely on static floor plans or simplified representations that do not reflect current inventory levels, equipment status, or temporary layout modifications. Embodiments of the digital twin module 314 may enable more accurate distance calculations and path optimization by providing detailed, current information about warehouse conditions, potentially leading to more realistic and achievable task scheduling.

Embodiments of the cost computation engine 312 may offer advantages over traditional cost calculation methods by incorporating multiple cost factors, including travel costs, labor costs, equipment utilization costs, and opportunity costs related to resource idle time. Conventional systems may focus primarily on minimizing travel distance without considering the broader financial implications of different task scheduling strategies. The comprehensive cost analysis provided by embodiments of the cost computation engine 312 may enable more informed decision-making that balances operational efficiency with financial considerations.

The spatiotemporal clustering approach employed by embodiments of the clustering module 304 may provide advantages over conventional clustering methods that typically consider only spatial proximity or task similarity. By computing distances between task locations in the form of traversable paths and incorporating temporal constraints, embodiments of the clustering module 304 may generate more realistic and executable task groupings. Traditional clustering approaches may group tasks that are spatially close but require conflicting resources or have incompatible timing requirements, potentially leading to scheduling conflicts during execution.

Embodiments of the routing/sequencing module 308 may offer advantages over conventional routing algorithms by incorporating pickup and delivery constraints along with precedence relationships between tasks. Traditional routing systems may optimize travel distance without considering the operational constraints that govern task execution sequences in warehouse environments. The routing/sequencing module 308 may generate initial execution plans 334 that account for these complex interdependencies, potentially reducing the likelihood of scheduling conflicts and improving overall task completion rates.

The greedy optimization techniques employed by embodiments of the system 300 may provide advantages over exhaustive search methods or complex mathematical programming approaches in terms of computational efficiency and real-time applicability. While traditional optimization methods may theoretically find optimal solutions, they may require excessive computation time that makes them impractical for real-time warehouse operations. Embodiments of the present invention may balance solution quality with computational efficiency, potentially providing near-optimal solutions within timeframes suitable for dynamic warehouse environments.

Embodiments of the present invention include features which may be implemented using one or more computers, computer processors, and/or other elements of a computer system. For example, the batch optimization system 300 may automatically analyze data (such as sales history data 152) to generate the simulated order book 160, and then generate the slotting strategy 168 automatically based on the order book 160, among other inputs. The batch optimization system 300 may also automatically update the order book 160 and the slotting strategy 168 in response to changes in the warehouse, such as changes in the inventory of the warehouse. These automated functions may provide significant improvements in efficiency and accuracy compared to manual approaches, as the batch optimization system 300 may process large volumes of data and complex relationships that would be impractical to manage manually.

The prediction engine 102 may generate target allocations 158 based on inputs such as sales history data 152, demand forecast data 154, and supply chain plan 156. This prediction engine 102 may utilize algorithms and data processing techniques that leverage substantial computational resources to analyze patterns and relationships within large datasets. For example, the prediction engine 102 may employ statistical models, machine learning algorithms, and/or optimization techniques to identify optimal inventory allocations based on historical trends and future projections. These computational approaches may enable the prediction engine 102 to generate more accurate and efficient allocation strategies than would be possible through manual analysis.

The digital twin 140 of the warehouse represents a technical advancement in warehouse management. This virtual model may be dynamically updated in real-time to mirror the physical state of the warehouse, incorporating changes in inventory, layout modifications, and operational adjustments. As shown in FIG. 1, the digital twin 140 may receive input from current inventory 142, ASNs 144, and inventory entries 146 to maintain an accurate representation of the warehouse environment. The digital twin 140 may enable simulations and optimizations that transform planning and operational strategies within the warehouse, effectively converting data into actionable insights and operational enhancements. For example, the digital twin 140 may allow warehouse managers to visualize the impact of different slotting strategies before implementing them physically, potentially reducing costs and improving efficiency.

Embodiments of the present invention may leverage computer technology to address complex problems in warehouse management. Each component, from the prediction engine 102 and digital twin 140 to the implementation of sophisticated pathfinding algorithms, may offer technological solutions to technological problems. For example, the cost computation engine 106 may calculate various costs 162 associated with different warehouse configurations and slotting strategies, enabling more informed decision-making. The product affinities engine 108 may analyze relationships between products based on sales patterns, generating affinity inference 164 data that may be used to optimize product placement within the warehouse. These components may work together to create a comprehensive system that addresses the multifaceted challenges of modern warehouse management.

Embodiments of the batch optimization system 300 and method 400 may incorporate several features that contribute to improving warehouse operations. For example, as shown in FIG. 3, the digital twin module 314 may create and maintain a virtual representation of the warehouse environment, providing a detailed, three-dimensional model that mirrors the physical warehouse and enables real-time decision-making and optimization. The machine learning module 306 may analyze historical task data 326, performance metrics 328, and current operational constraints 322 to generate optimized task groupings 330 and resource predictions 332, allowing the batch optimization system 300 to adapt and improve optimization strategies over time. The batch optimization problem may be addressed as a non-convex optimization problem, where the batch optimization system 300 may employ greedy techniques to efficiently reach viable near-optimal solutions in a time-sensitive manner, enabling the batch optimization system 300 to handle complex warehouse scenarios and provide practical solutions within operational time constraints.

The clustering module 304 may utilize a spatio-temporal approach to group tasks, considering both spatial proximity within the warehouse and temporal relationships between tasks. This approach may optimize task execution efficiency by minimizing travel time and maximizing resource utilization within specific warehouse areas. Referring to FIG. 4, the clustering module 304 may support operation 404, where tasks are organized into a plurality of executable batches. The routing/sequencing module 308 may generate optimized routes for task execution, considering factors such as travel time, task dependencies, and operational constraints, allowing for real-time adjustments to task sequences based on changing warehouse conditions. The feedback/iteration module 310 may employ specific reclustering criteria based on performance metrics such as tardiness data 336 and surplus time data 338, continuously refining task assignments and sequences, leading to ongoing improvements in operational efficiency. These modules may work together to implement the iterative refinement process described in operation 412 of method 400.

The batch optimization system 300 may be designed to work in conjunction with automated slotting systems, providing a comprehensive warehouse optimization solution that leverages synergies between optimal item placement and task scheduling. As shown in FIG. 3, the integration module 316 may connect the batch optimization system 300 with an automated slotting system, allowing for the generation of an integrated warehouse optimization plan 354 based on the slotting strategy 350 and batch optimization results. The batch optimization system 300 may process large amounts of data, make real-time decisions, and continuously adapt to changing conditions. For example, the input processing module 302 may receive and process task data 318 and constraints 320 from various sources, while the digital twin module 314 may incorporate real-time operational data 346 to maintain an updated virtual representation of the warehouse 348. These capabilities may enable warehouse operators to respond more effectively to changing conditions and optimize resource utilization across different operational scenarios.

The present disclosure provides a method for optimizing batch processing in a facility, performed by at least one computer processor executing computer program instructions stored on at least one non-transitory computer-readable medium. The method includes receiving task data and constraints for facility operations, organizing tasks into a plurality of executable batches, generating an initial execution plan for executing tasks within each batch in the plurality of executable batches, calculating performance metrics for each batch in the plurality of executable batches, iteratively refining the initial execution plan based on the calculated performance metrics, and outputting the iteratively refined plan for assignment to facility resources.

In various embodiments, the task data comprises information about warehouse operations including at least one of inbound unloading, putaway, outbound picking, packing, replenishment, or cycle counting. The task data may comprise task location information, task type information, required skill sets for task execution, equipment requirements, and task deadline information.

The constraints may comprise precedence constraints that define dependencies between tasks, wherein certain tasks must be completed before other tasks can be initiated. The constraints may comprise capacity constraints that limit the number of tasks that can be assigned to each resource or executed within a specific time period. The constraints may comprise spatial constraints that define physical limitations within the facility, including aisle accessibility, equipment positioning, and storage area restrictions.

In some embodiments, organizing tasks into a plurality of executable batches comprises clustering tasks based on spatiotemporal similarity, wherein tasks are grouped based on both spatial proximity within the facility and temporal relationships between tasks. Clustering tasks based on spatiotemporal similarity may comprise computing distances between task locations in the form of traversable paths within the facility layout. Organizing tasks into a plurality of executable batches may comprise applying multi-stage constrained clustering that considers operational capacity constraints to refine task clusters after initial grouping. Organizing tasks into a plurality of executable batches may comprise considering task interdependencies when forming batches, wherein dependent tasks are grouped to minimize waiting times between related operations.

Generating an initial execution plan may comprise generating an initial route for each batch that minimizes travel time between task locations while considering precedence constraints between tasks. Generating an initial execution plan may comprise employing a routing algorithm that incorporates pickup and delivery constraints to ensure proper sequencing of interdependent tasks. Generating an initial execution plan may comprise calculating an optimal sequence of tasks within each batch to minimize both task tardiness and total completion time for the batch. Generating an initial execution plan may comprise applying greedy optimization techniques to determine task sequencing that balances execution efficiency with resource utilization constraints.

Calculating performance metrics for each batch may comprise calculating tardiness for each task within the batch, wherein tardiness is measured as the amount of time by which a task completion exceeds its designated deadline. Calculating performance metrics for each batch may comprise calculating surplus time for each batch, wherein surplus time is determined as the difference between the minimum task deadline within the batch and the actual batch completion time. Calculating performance metrics for each batch may comprise computing resource utilization efficiency by measuring the ratio of productive task execution time to total allocated resource time for each batch. Calculating performance metrics for each batch may comprise calculating a composite efficiency score that combines tardiness, surplus time, and resource utilization metrics into a single performance indicator for each batch.

Iteratively refining the initial execution plan may comprise reassigning tasks with high tardiness from a first batch to a second batch that has surplus time and is spatially proximate to the first batch. Iteratively refining the initial execution plan may comprise applying a feedback mechanism that reclusters tasks when tardiness exceeds a predetermined threshold in any batch. Iteratively refining the initial execution plan may comprise employing greedy optimization techniques to make locally optimal task reassignments that improve overall batch performance metrics. Iteratively refining the initial execution plan may comprise continuing refinement iterations until convergence criteria are met, wherein the convergence criteria include achieving zero tardiness and minimized surplus time across all batches.

Outputting the iteratively refined plan may comprise generating resource-specific task assignments that include detailed scheduling information for each assigned resource, including task sequences, estimated completion times, and required equipment specifications. Outputting the iteratively refined plan may comprise providing real-time updates to the plan based on changing facility conditions, wherein the updates are automatically pushed to assigned resources when task reassignments occur. Outputting the iteratively refined plan may comprise generating machine-readable instructions that interface with automated equipment in the facility to coordinate human and automated resource activities. Outputting the iteratively refined plan may comprise integrating the plan with existing facility management systems to automatically update inventory tracking, equipment scheduling, and workforce management databases.

In further embodiments, the method may further comprise maintaining a digital twin of the facility that provides a virtual representation of the facility layout, wherein organizing tasks into a plurality of executable batches comprises using the digital twin to determine spatial proximity between task locations. The digital twin may comprise a three-dimensional model of the facility that includes rack locations, aisle configurations, and equipment positioning, and wherein generating an initial execution plan comprises using the digital twin to calculate optimal travel paths between task locations. The digital twin may provide pathfinding capabilities that calculate traversable routes between facility locations, and wherein generating an initial execution plan comprises using the pathfinding capabilities to determine optimal task sequences that minimize travel distance. The digital twin may integrate with facility sensors to receive real-time operational data, and wherein the method further comprises automatically updating task assignments based on real-time facility condition changes reflected in the digital twin.

In additional embodiments, organizing tasks into a plurality of executable batches comprises clustering tasks based on spatiotemporal similarity while computing distances as traversable paths, wherein generating an initial execution plan comprises incorporating pickup and delivery constraints for interdependent tasks, and wherein iteratively refining the initial execution plan comprises reassigning tasks between spatially proximate batches to balance tardiness and surplus time across the facility.

In other embodiments, calculating performance metrics comprises determining both tardiness and surplus time for each batch, wherein iteratively refining the initial execution plan comprises employing greedy optimization techniques to reassign tasks from batches with high tardiness to batches with surplus time, and wherein the refinement process continues until convergence criteria are met including achieving minimized tardiness and surplus time across all batches.

In further embodiments, the constraints comprise spatial constraints defining physical facility limitations and capacity constraints limiting task assignments, wherein organizing tasks comprises balancing batch sizes to optimize resource utilization while maintaining spatial efficiency, and wherein iteratively refining comprises dynamically adjusting batch boundaries based on real-time performance feedback while preserving both task similarity and spatial clustering constraints.

In additional embodiments, the constraints comprise appointment schedules, packing station throughput, and carrier arrival times, wherein generating an initial execution plan comprises incorporating real-time facility conditions including equipment status and workforce availability, wherein calculating performance metrics comprises determining batch completion variance by measuring deviations between predicted and actual completion times, and wherein outputting comprises providing real-time updates that are automatically pushed to assigned resources when task reassignments occur based on changing facility conditions.

It is to be understood that although the invention has been described above in terms of particular embodiments, the foregoing embodiments are provided as illustrative only, and do not limit or define the scope of the invention. Various other embodiments, including but not limited to the following, are also within the scope of the claims. For example, elements and components described herein may be further divided into additional components or joined together to form fewer components for performing the same functions.

Any of the functions disclosed herein may be implemented using means for performing those functions. Such means include, but are not limited to, any of the components disclosed herein, such as the computer-related components described below.

The techniques described above may be implemented, for example, in hardware, one or more computer programs tangibly stored on one or more computer-readable media, firmware, or any combination thereof. The techniques described above may be implemented in one or more computer programs executing on (or executable by) a programmable computer including any combination of any number of the following: a processor, a storage medium readable and/or writable by the processor (including, for example, volatile and non-volatile memory and/or storage elements), an input device, and an output device. Program code may be applied to input entered using the input device to perform the functions described and to generate output using the output device.

Any claims herein which affirmatively require a computer, a processor, a memory, or similar computer-related elements, are intended to require such elements, and should not be interpreted as if such elements are not present in or required by such claims. Such claims are not intended, and should not be interpreted, to cover methods and/or systems which lack the recited computer-related elements. For example, any method claim herein which recites that the claimed method is performed by a computer, a processor, a memory, and/or similar computer-related element, is intended to, and should only be interpreted to, encompass methods which are performed by the recited computer-related element(s). Such a method claim should not be interpreted, for example, to encompass a method that is performed mentally or by hand (e.g., using pencil and paper). Similarly, any product claim herein which recites that the claimed product includes a computer, a processor, a memory, and/or similar computer-related element, is intended to, and should only be interpreted to, encompass products which include the recited computer-related element(s). Such a product claim should not be interpreted, for example, to encompass a product that does not include the recited computer-related element(s).

Each computer program within the scope of the claims below may be implemented in any programming language, such as assembly language, machine language, a high-level procedural programming language, or an object-oriented programming language. The programming language may, for example, be a compiled or interpreted programming language.

Each such computer program may be implemented in a computer program product tangibly embodied in a machine-readable storage device for execution by a computer processor. Method steps of the invention may be performed by one or more computer processors executing a program tangibly embodied on a computer-readable medium to perform functions of the invention by operating on input and generating output. Suitable processors include, by way of example, both general and special purpose microprocessors. Generally, the processor receives (reads) instructions and data from a memory (such as a read-only memory and/or a random access memory) and writes (stores) instructions and data to the memory. Storage devices suitable for tangibly embodying computer program instructions and data include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A computer can generally also receive (read) programs and data from, and write (store) programs and data to, a non-transitory computer-readable storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium.

Any data disclosed herein may be implemented, for example, in one or more data structures tangibly stored on a non-transitory computer-readable medium. Embodiments of the invention may store such data in such data structure(s) and read such data from such data structure(s).

Any step or act disclosed herein as being performed, or capable of being performed, by a computer or other machine, may be performed automatically by a computer or other machine, whether or not explicitly disclosed as such herein. A step or act that is performed automatically is performed solely by a computer or other machine, without human intervention. A step or act that is performed automatically may, for example, operate solely on inputs received from a computer or other machine, and not from a human. A step or act that is performed automatically may, for example, be initiated by a signal received from a computer or other machine, and not from a human. A step or act that is performed automatically may, for example, provide output to a computer or other machine, and not to a human.

The terms “A or B,” “at least one of A or/and B,” “at least one of A and B,” “at least one of A or B,” or “one or more of A or/and B” used in the various embodiments of the present disclosure include any and all combinations of words enumerated with it. For example, “A or B,” “at least one of A and B” or “at least one of A or B” may mean: (1) including at least one A, (2) including at least one B, (3) including either A or B, or (4) including both at least one A and at least one B.

Although terms such as “optimize” and “optimal” are used herein, in practice, embodiments of the present invention may include methods which produce outputs that are not optimal, or which are not known to be optimal, but which nevertheless are useful. For example, embodiments of the present invention may produce an output which approximates an optimal solution, within some degree of error. As a result, terms herein such as “optimize” and “optimal” should be understood to refer not only to processes which produce optimal outputs, but also processes which produce outputs that approximate an optimal solution, within some degree of error.

What is claimed is:

1. A method for optimizing batch processing in a facility, the method performed by at least one computer processor executing computer program instructions stored on at least one non-transitory computer-readable medium, the method comprising:
receiving task data and constraints for facility operations;
organizing tasks into a plurality of executable batches;
generating an initial execution plan for executing tasks within each batch in the plurality of executable batches;
calculating performance metrics for each batch in the plurality of executable batches;
iteratively refining the initial execution plan based on the calculated performance metrics; and
outputting the iteratively refined plan for assignment to facility resources.

2. The method of claim 1, wherein organizing tasks into a plurality of executable batches comprises clustering tasks based on spatiotemporal similarity, wherein tasks are grouped based on both spatial proximity within the facility and temporal relationships between tasks.

3. The method of claim 2, wherein clustering tasks based on spatiotemporal similarity comprises computing distances between task locations in the form of traversable paths within the facility layout.

4. The method of claim 1, wherein generating an initial execution plan comprises employing a routing algorithm that incorporates pickup and delivery constraints to ensure proper sequencing of interdependent tasks.

5. The method of claim 1, wherein generating an initial execution plan comprises calculating an optimal sequence of tasks within each batch to minimize both task tardiness and total completion time for the batch.

6. The method of claim 1, wherein generating an initial execution plan comprises applying greedy optimization techniques to determine task sequencing that balances execution efficiency with resource utilization constraints.

7. The method of claim 1, wherein iteratively refining the initial execution plan comprises reassigning tasks with high tardiness from a first batch to a second batch that has surplus time and is spatially proximate to the first batch.

8. The method of claim 1, wherein iteratively refining the initial execution plan comprises applying a feedback mechanism that reclusters tasks when tardiness exceeds a predetermined threshold in any batch.

9. The method of claim 1, wherein iteratively refining the initial execution plan comprises employing greedy optimization techniques to make locally optimal task reassignments that improve overall batch performance metrics.

10. The method of claim 1, wherein iteratively refining the initial execution plan comprises continuing refinement iterations until convergence criteria are met, wherein the convergence criteria include achieving zero tardiness and minimized surplus time across all batches.

11. The method of claim 1, wherein organizing tasks into a plurality of executable batches comprises clustering tasks based on spatiotemporal similarity while computing distances as traversable paths, wherein generating an initial execution plan comprises incorporating pickup and delivery constraints for interdependent tasks, and wherein iteratively refining the initial execution plan comprises reassigning tasks between spatially proximate batches to balance tardiness and surplus time across the facility.

12. The method of claim 1, wherein calculating performance metrics comprises determining both tardiness and surplus time for each batch, wherein iteratively refining the initial execution plan comprises employing greedy optimization techniques to reassign tasks from batches with high tardiness to batches with surplus time, and wherein the refinement process continues until convergence criteria are met including achieving minimized tardiness and surplus time across all batches.

13. A system for optimizing batch processing in a facility, the system comprising at least one non-transitory computer-readable medium having computer program instructions stored thereon, wherein the computer program instructions are executable by at least one computer processor to perform a method, the method comprising:
receiving task data and constraints for facility operations;
organizing tasks into a plurality of executable batches;
generating an initial execution plan for executing tasks within each batch in the plurality of executable batches;
calculating performance metrics for each batch in the plurality of executable batches;
iteratively refining the initial execution plan based on the calculated performance metrics; and
outputting the iteratively refined plan for assignment to facility resources.

14. The system of claim 13, wherein organizing tasks into a plurality of executable batches comprises clustering tasks based on spatiotemporal similarity, wherein tasks are grouped based on both spatial proximity within the facility and temporal relationships between tasks.

15. The system of claim 14, wherein clustering tasks based on spatiotemporal similarity comprises computing distances between task locations in the form of traversable paths within the facility layout.

16. The system of claim 13, wherein generating an initial execution plan comprises employing a routing algorithm that incorporates pickup and delivery constraints to ensure proper sequencing of interdependent tasks.

17. The system of claim 13, wherein iteratively refining the initial execution plan comprises applying a feedback mechanism that reclusters tasks when tardiness exceeds a predetermined threshold in any batch.

18. The system of claim 13, wherein iteratively refining the initial execution plan comprises continuing refinement iterations until convergence criteria are met, wherein the convergence criteria include achieving zero tardiness and minimized surplus time across all batches.

19. The system of claim 13, wherein organizing tasks into a plurality of executable batches comprises clustering tasks based on spatiotemporal similarity while computing distances as traversable paths, wherein generating an initial execution plan comprises incorporating pickup and delivery constraints for interdependent tasks, and wherein iteratively refining the initial execution plan comprises reassigning tasks between spatially proximate batches to balance tardiness and surplus time across the facility.

20. The system of claim 13, wherein calculating performance metrics comprises determining both tardiness and surplus time for each batch, wherein iteratively refining the initial execution plan comprises employing greedy optimization techniques to reassign tasks from batches with high tardiness to batches with surplus time, and wherein the refinement process continues until convergence criteria are met including achieving minimized tardiness and surplus time across all batches.
